(19) United States
(12) Patent Application Publication
(10) Pub. No.: US 2026/0248157 A1
(43) Pub. Date: Aug. 27, 2026

(54) COMPOSITIONS FOR REDUCING METHANE EMISSION

(71) Applicant: MOOTRAL INNOVATIONS LIMITED, HITCHIN (GB)

(72) Inventors: Daniel Wilhelm NEEF, Hitchin (GB); Phanee MANGANAS, Hitchin (GB)

(73) Assignee: MOOTRAL INNOVATIONS LIMITED, HITCHIN (GB)

(21) Appl. No.: 18/874,735

(22) PCT Filed: Jun. 20, 2023
(86) PCT No.: PCT/GB2023/051607

§ 371 Date: Dec. 13, 2024

(30) Foreign Application Priority Data
Jun. 21, 2022 (GB) 2209089.8

(51) Int. Cl. A23K 20/105; A23K 10/30; A23K 20/111; A23K 20/121; A23K 20/132; A23K 20/163; A23K 50/10

(52) U.S. Cl. CPC A23K 20/105; A23K 10/30; A23K 20/111; A23K 20/121; A23K 20/132; A23K 20/163; A23K 50/10

(57) ABSTRACT

Animal feed compositions for reducing methane emission and/or for inhibiting one or more methane producing organisms (i.e., methanogens). Also included are the use of said compositions to reduce methane emission from animals such as ruminant animals, to inhibit methanogenesis by one or more methanogens in said animals, and/or to increase milk yield and/or body weight gain of said animals is described, as well as related methods.

### FIELD OF THE INVENTION

The present invention relates to compositions, such as animal feed compositions, for reducing methane emission and/or for inhibiting one or more methane producing organisms (i.e., methanogens). The present invention also relates to the use of said compositions to reduce methane emission from animals such as ruminant animals, to inhibit methanogenesis by one or more methanogens in said animals, and/or to increase milk yield and/or body weight gain of said animals, as well as related methods.

### BACKGROUND OF THE INVENTION

Ruminant animals consume feeds containing carbon and nitrogen, which are converted into various materials including carbon-rich lipids, fats, fatty acids, and carbohydrates and nitrogen-rich proteins, nucleic acids, amino acids, and nucleotides.

However, ruminant animals, such as cattle, sheep and goats, are inefficient users of carbon. Ruminant methane production from carbon represents a loss of energy, from 2 to 12% of gross energy intake from feed. Particular types of microbes in the gut of ruminant animals use the end products of the fermentation of nutrients consumed by the animal to produce methane as a by-product. In addition to the negative effects of methane on climate change, this also reduces the nutrients available for use by the animal, for example, to increase in milk yield and body weight gain.

There is a need to develop alternative and/or improved compositions for reducing methane emissions from animals such as ruminant animals, and/or to increase milk yield and/or body weight gain of such animals, for example, by increasing the availability of nutrients to an animal.

The present invention addresses these needs by providing compositions, for example, in the form of animal feed (e.g., animal feed supplement, animal feed additive and complementary feed), that reduce the emission of methane emitted to the environment, and/or which improves milk yield and/or body weight gain of an animal, and more generally improves animal growth.

The present invention addresses this need, at least in part, by providing compositions which inhibit methanogenesis by methanogens.

### SUMMARY OF THE INVENTION

According to the present invention, in a first aspect, there is provided a composition for reducing methane emission comprising a trihalomethane other than dibromochloromethane and at least one other compound selected from dibromochloromethane, dibromomethane (DBM), diallyl disulfide (DADS), diallyl trisulfide (DATS), dimethyl disulfide, dipropyl disulfide (DPDS), prenylnaringenin (for example, 6-prenylnaringenin or 8-prenylnaringenin), bavachin, bavachinin, corylifol (for example, corylifol A or corylifol C), morusin, isobavachalcone, naringenin, quercetin, xanthohumol, tannic acid, cinnamon bark oil, garlic oil, sandalwood oil, thyme red oil, lemongrass oil, lemon verbena oil, carvacrol, citral, cinnamaldehyde, hexylcinnamaldehyde (for example, α-hexylcinnamaldehyde or 2-hexylcinnamaldehyde), sclareol, saikosaponin (for example, saikosaponin A, saikosaponin b2, saikosaponin C or saikosaponin D), ursolic acid, ginsenoside (for example, ginsenoside Rb1, ginsenoside Rb2, ginsenoside Rc, ginsenoside Rd, ginsenoside Re, ginsenoside Rg1 or ginsenoside Rf), dibromoacetic acid, 3-nitrooxypropanol, pyromellitic diimide and any combination thereof. In certain embodiments, the composition may consist essentially of or consist of a trihalomethane other than dibromochloromethane and said compound(s). The composition is suitable for reducing methane emission by an animal, and/or inhibiting methanogenesis by one or more methanogens in an animal, and/or increasing milk yield and/or body weight gain of an animal, for example, a ruminant animal such as a cow, goat or sheep.

Also according to the present invention, in a second aspect, there is provided an animal feed comprising the composition of the first aspect or any embodiment thereof, for example, an animal feed supplement, an animal feed additive or a complementary feed.

Also according to the present invention, in a third aspect, there is provided the use of the composition of the first aspect or the animal feed of the second aspect, for reducing methane emission or production by an animal, and/or inhibiting methanogenesis by one or more methanogens in an animal, and/or increasing milk yield and/or body weight gain of an animal, for example, a ruminant animal such as a cow, goat or sheep.

Also according to the present invention, in a fourth aspect, there is provided a method of reducing methane emission by an animal, and/or inhibiting methanogenesis by one or more methanogens in an animal, and/or increasing milk yield and/or body weight gain of an animal, the method comprising administering (e.g., by consumption of the composition or animal feed by the animal) the composition to the animal, more particularly a ruminant animal such as a cow, goat or sheep.

Embodiments of the invention will be further described in the detailed description. Any embodiment described herein or any combination of embodiments described herein is applicable to any one or more aspect of the present invention unless clearly contradicted by context.

### DESCRIPTION OF THE FIGURES

FIG. 1: Methane inhibition of halogen methane analogues as a sole compound

FIG. 2: Methane inhibition of iodoform and dibromomethane (DBM) as a sole compound and in combination

FIG. 3: Methane inhibition of iodoform and pyromellitic diimide (PD) as a sole compound and in combination

FIG. 4: Methane inhibition of iodoform and naringenin as a sole compound and in combination

FIG. 5: Methane inhibition of iodoform and dipropyl disulfide (DPDS) as a sole compound and in combination

FIG. 6: Methane inhibition of iodoform and garlic oil as a sole compound and in combination

FIG. 7: Methane inhibition of iodoform and diallyl trisulfide (DATS) as a sole compound and in combination

FIG. 8: Methane inhibition of iodoform and diallyl disulfide (DADS) as a sole compound and in combination

FIG. 9: Methane inhibition of iodoform and α-hexylcinnamaldehyde as a sole compound and in combination

FIG. 10: Methane inhibition of iodoform and thyme red oil (TRO) as a sole compound and in combination

FIG. 11: Methane inhibition of iodoform and lemongrass oil (LGO) as a sole compound and in combination

FIG. 12: Methane inhibition of iodoform, dibromomethane (DBM) and naringenin as a sole compound and in combination

FIG. 13: Methane inhibition of iodoform, dibromomethane (DBM) and diallyl trisulfide (DATS) as a sole compound and in combination

FIG. 14: Methane inhibition of iodoform, dibromomethane and garlic oil as a sole compound and in combination

FIG. 15: Methane inhibition of iodoform, dibromomethane and diallyl disulfide (DADS) as a sole compound and in combination.

FIG. 16: Methane inhibition of iodoform, dibromomethane and dipropyl disulfide (DPDS) as a sole compound and in combination

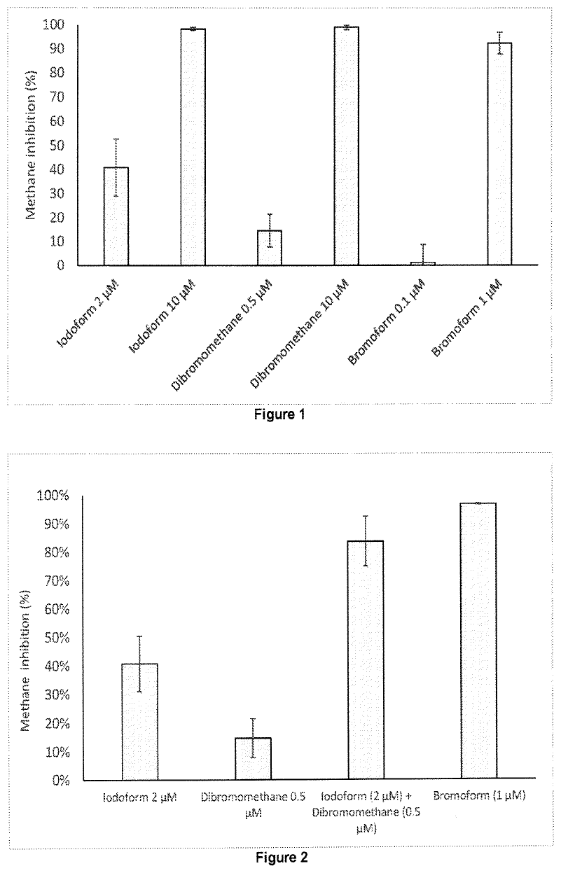

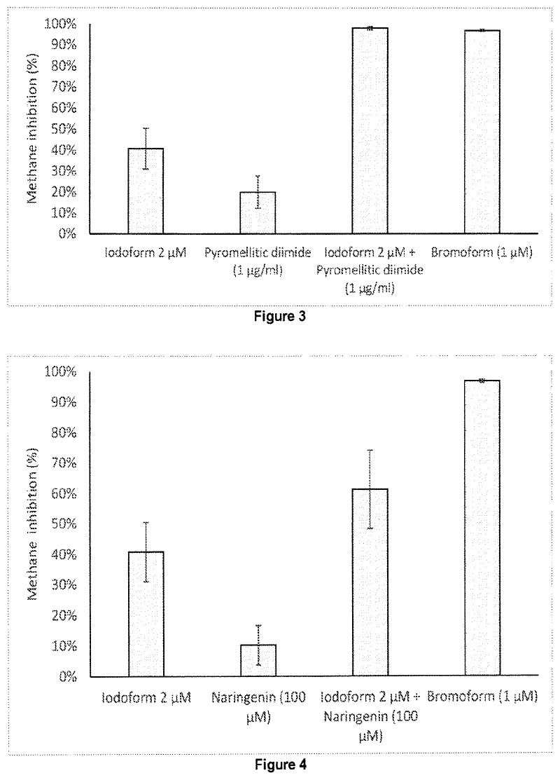

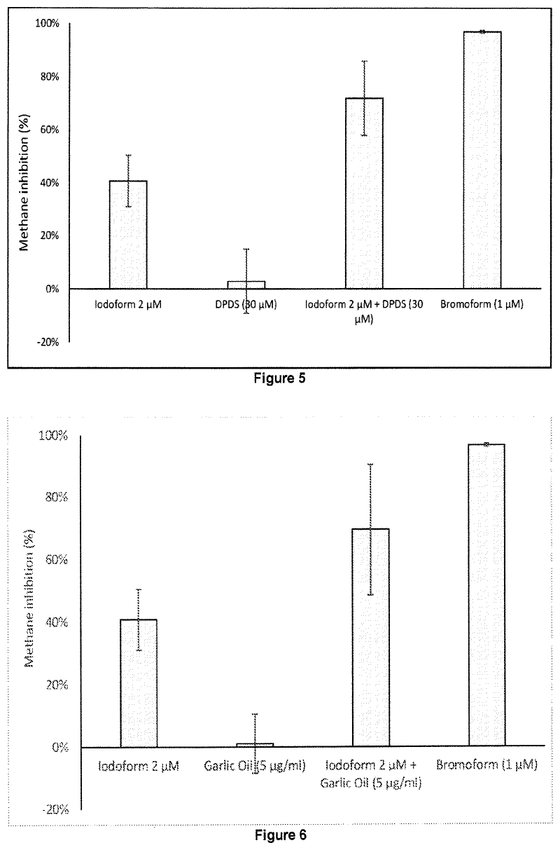

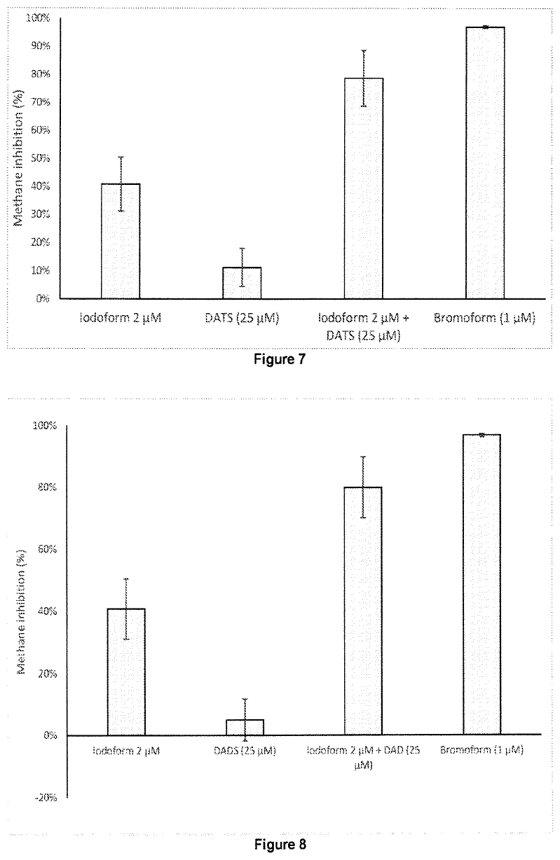

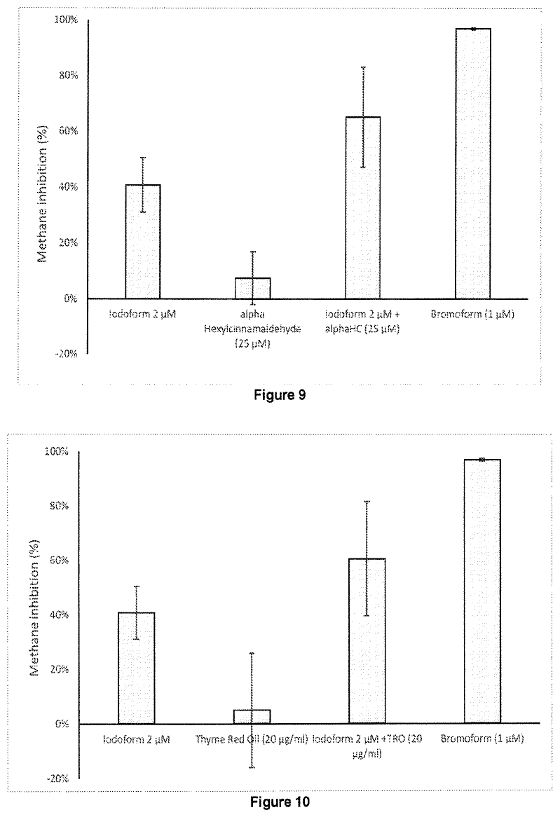

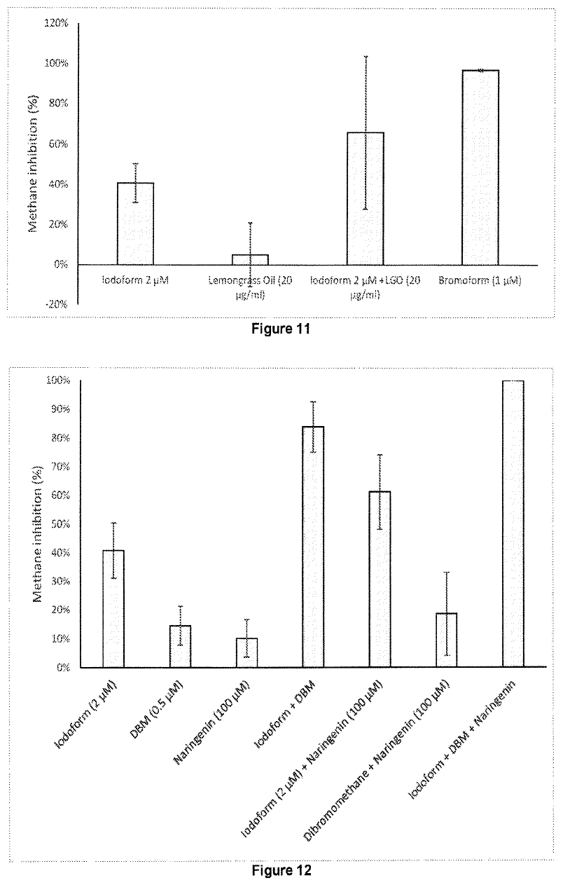

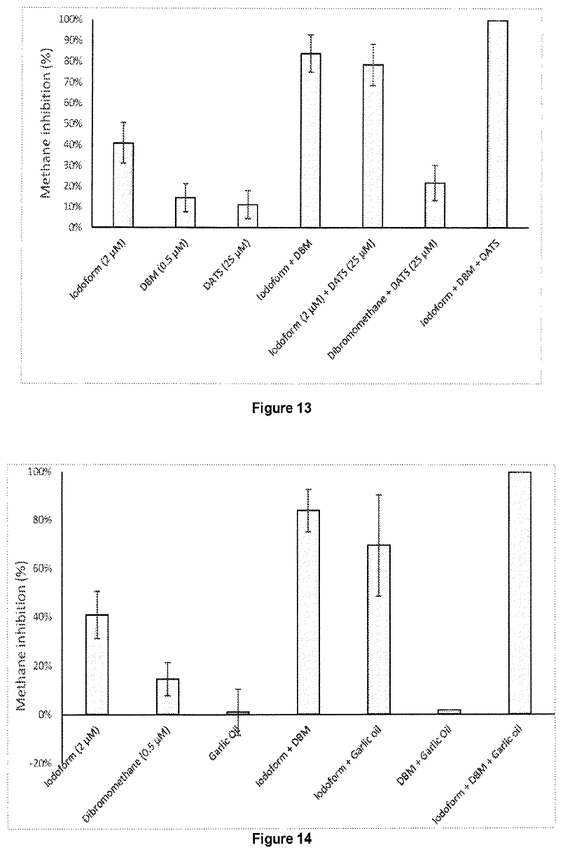

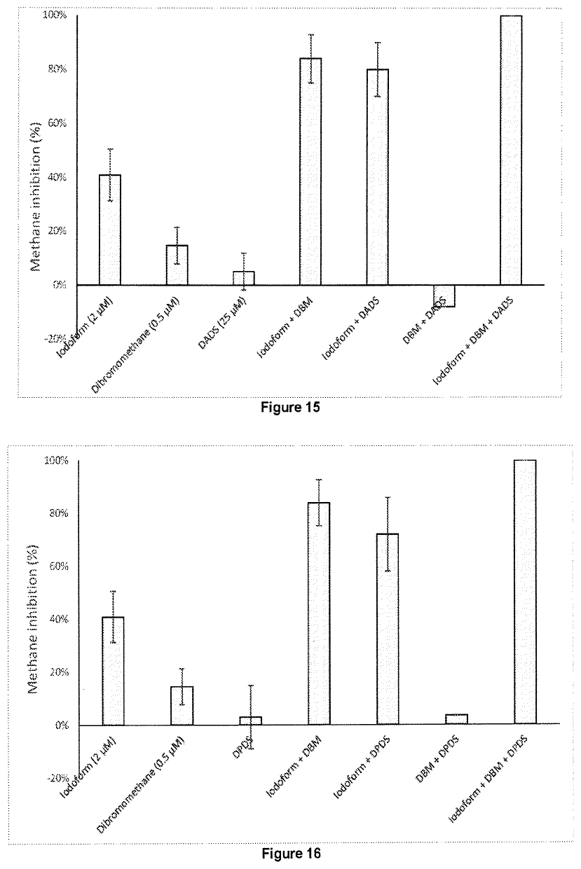

### DETAILED DESCRIPTION OF THE INVENTION

The present invention is based, at least in part, on the surprising finding that a combination of a trihalomethane other than dibromochloromethane, for example, bromoform (CHBr₃) or iodoform (CHI₃), and at least one other compound as described herein can reduce methane production and/or emissions by animals such as ruminant animals. Without wishing to be bound by theory, it is believed that a trihalomethane other than dibromochloromethane, for example, bromoform (CHBr₃) or iodoform (CHI₃), and the at least one other compound act together synergistically to inhibit methanogenesis by methanogens, for example, in the rumen and hind gut of an animal such as a ruminant animal, thereby inhibiting methane production. By “act together synergistically” is meant that the methanogenesis inhibiting capability of the composition containing the mixture of a trihalomethane other than dibromochloromethane, for example, bromoform (CHBr₃) or iodoform (CHI₃), and at least one other compound as described herein is greater than the sum of the methanogenesis inhibiting capability of either component taken alone. It is believed that the inhibition of methanogenesis may occur by different modes of action including for example: reducing methanogenic processes; by limiting, inhibiting or preventing enzymes involved in methanogenesis from taking part in that process; or by reducing methanogenic organisms by limiting their growth or killing them.

Hereinafter, the invention shall be described according to preferred embodiments of the present invention and by referring to the accompanying description. However, it is to be understood that limiting the description to the preferred embodiments of the invention is merely to facilitate discussion of the present invention and it is envisioned that those skilled in the art may devise various modifications without departing from the scope of the appended claims.

Where the term “at least one” or “one or more” occurs hereinbefore and hereinafter, this signifies in particular one to twenty or one to ten, for preference one to five or one to three, and in particular one or, further, two of the features enumerated, such as components. Where ranges are indicated, such as weight percentage ranges, these include the limit values indicated; thus, for example, “between X and Y” signifies “from and including X up to and including Y”.

The term “therapeutic treatment” or “therapeutic method”, also includes prophylaxis and the alleviation of symptoms of a disease and/or disorder in a subject, although not cosmetic treatments. The expression “treating or preventing” and analogous terms used herein refers to all forms of healthcare intended to remove or avoid the disease and/or disorder or to relieve its symptoms, including preventive and curative care, as judged according to any of the tests available according to the prevailing medical practice. An intervention that aims with reasonable expectation to achieve a particular result but does not always do so is included within the expression “treating or preventing”. An intervention that succeeds in slowing or halting progression of a disease and/or disorder is included within the expression “treating or preventing”.

The term “organohalogen” refers to an organic compound that contains at least one halogen.

The term “trihalomethane” refers to a CHX₃ species where X is a halogen, for example, CI, Br, I or mixtures thereof. Preferably X is Br or I. The trihalomethane is other than dibromochloromethane. Advantageously, the trihalomethane is bromoform (CHBr₃) and/or iodoform (CHI₃).

The term “consisting of” excludes any additional element, step or ingredient not explicitly recited.

The term “consisting essentially of” excludes any additional element, step or ingredient not explicitly recited unless the additional element, step or ingredient does not materially affect the basic and novel properties of the invention. Where the one or more additional element(s), step(s) or ingredient(s) is/are one or more additional component(s) of a product or composition, the total amount of the additional component(s) in the composition may, for example, be limited to 20 wt. %. For example, the total amount of the additional component(s) in the composition may be limited to 19 wt. % or 18 wt. % or 17 wt. % or 16 wt. % or 15 wt. % or 14 wt. % or 13 wt. % or 12 wt. % or 11 wt. % or 10 wt. % or 9 wt. % or 8 wt. % or 7 wt. % or 6 wt. % or 5 wt. % or 4 wt. % or 3 wt. % or 2 wt. % or 1 wt. %.

According to the present invention there is provided a composition, for example, for reducing methane emission/production by an animal, comprising a trihalomethane other than dibromochloromethane (for example, bromoform or iodoform) and at least one other compound selected from a group consisting of dibromochloromethane, dibromomethane, diallyl disulfide, diallyl trisulfide, dimethyl disulfide, dipropyl disulfide, prenylnaringenin (for example, 6-prenylnaringenin or 8-prenylnaringenin), bavachin, bavachinin, corylifol (for example, corylifol A or corylifol C), morusin, isobavachalcone, naringenin, quercetin, xanthohumol, tannic acid, cinnamon bark oil, garlic oil, sandalwood oil, thyme red oil, lemongrass oil, lemon verbena oil, carvacrol, citral, cinnamaldehyde, hexylcinnamaldehyde (for example, α-hexylcinnamaldehyde or 2-hexylcinnamaldehyde), sclareol, saikosaponin (for example, saikosaponin A, saikosaponin b2, saikosaponin C or saikosaponin D), ursolic acid, ginsenoside (for example, ginsenoside Rb1, ginsenoside Rb2, ginsenoside Rc, ginsenoside Rd, ginsenoside Re, ginsenoside Rg1 or ginsenoside Rf), dibromoacetic acid, 3-nitrooxypropanol, pyromellitic diimide and any combination thereof. The composition may be used for inhibiting methanogenesis by one or more methanogens, or for increasing milk yield and/or body weight gain of an animal.

Alternatively, the at least one other compound may be selected from dibromochloromethane, dibromomethane, diallyl disulfide, diallyl trisulfide, dimethyl disulfide, dipropyl disulfide, 8-prenylnaringenin, bavachin, bavachinin, corylifol A, morusin, isobavachalcone, naringenin, quercetin, silibinin, xanthohumol, tannic acid, cinnamon bark oil, garlic oil, sandalwood oil, thyme red oil, lemongrass oil, lemon verbena oil, carvacrol, citral, cinnamaldehyde, α-hexylcinnamaldehyde, abietic acid, sclareol, tanshinone IIA, saikosaponin b2, ursolic acid, ginsenoside Rb2, dibromoacetic acid, 3-nitrooxypropanol, pyromellitic diimide and any combination thereof.

The trihalomethane is other than dibromochloromethane. The trihalomethane may be a compound in which the halogen is the same species. The trihalomethane may be bromoform (CHBr₃) and/or iodoform (CHI₃). The trihalomethane may be bromoform (CHBr₃). The trihalomethane may be iodoform (CHI₃).

The composition, for example, for reducing methane emission/production by an animal, may comprise bromoform and at least one other compound selected from a group consisting of dibromochloromethane, diallyl disulfide, diallyl trisulfide, dimethyl disulfide, dipropyl disulfide, prenylnaringenin (for example, 6-prenylnaringenin or 8-prenylnaringenin), bavachin, bavachinin, corylifol (for example, corylifol A or corylifol C), morusin, isobavachalcone, naringenin, quercetin, xanthohumol, tannic acid, cinnamon bark oil, garlic oil, sandalwood oil, thyme red oil, lemongrass oil, lemon verbena oil, carvacrol, citral, cinnamaldehyde, hexylcinnamaldehyde (for example, α-hexylcinnamaldehyde or 2-hexylcinnamaldehyde), sclareol, saikosaponin (for example, saikosaponin A, saikosaponin b2, saikosaponin C or saikosaponin D), ursolic acid, ginsenoside (for example, ginsenoside Rb1, ginsenoside Rb2, ginsenoside Rc, ginsenoside Rd, ginsenoside Re, ginsenoside Rg1 or ginsenoside Rf), dibromoacetic acid, 3-nitrooxypropanol, and any combination thereof.

The composition, for example, for reducing methane emission/production by an animal, may comprise iodoform and at least one other compound selected from a group consisting of dibromomethane, pyromellitic diimide, naringenin, dipropyl disulfide, garlic oil, diallyl disulfide, diallyl trisulfide, hexylcinnamaldehyde (for example, α-hexylcinnamaldehyde), thyme red oil, lemongrass oil, and any combination thereof.

Trihalomethanes may be obtained synthetically or from natural sources. For example, a biological source of organohalogen compounds such as bromoform or iodoform is organohalogen-rich marine macroalgae. Organohalogen-rich marine macroalgae includes at least one species of marine macroalgae selected from the group consisting of: Asparagopsis armata; Asparagopsis taxiformis; Dictyota species; Oedogonium species; Ulva species; and Cladophora patentiramea. Thus, in some embodiments, the trihalomethane compound derives from an organohalogen-rich marine microalgae, for example, selected from the group consisting of: Asparagopsis armata; Asparagopsis taxiformis; Dictyota species; Oedogonium species; Ulva species; and Cladophora patentiramea.

The trihalomethane compounds may be produced by bacteria, fungi and cyanobacteria. For example, the bacteria include one species of bacteria selected from the group consisting of: Streptomyces sp. and Zobellia galactanivorans. For example, the fungi include one species of fungi selected from the group consisting of: Pyricularia oryzae, Curvularia inaequalis, Pyrenophora tritici-repentis, Embellisia didymospora, Agaricus species e.g. Agaricus angusticystidiatus; Agaricus iodoformicus Speg.; Agaricus moelleri; Agaricus phaeolepidotus; and Agaricus pseudochitonia, Mycena species e.g. Mycena pipterygia (Scop.: Fr.) Gray; and Mycena arcangeliana, Jahnoporus species e.g. Jahnoporus hirtus, Cortinarius species e.g. Cortinarius obtusus (Fr.) and Cortinarius seidlii, and Hemileccinum impolitum. For example, the cyanobacteria include one species of cyanobacteria selected from the group consisting of: Trichodesmium erythraeum, Synechococcus sp. and Acaryochloris marina.

The trihalomethane may be synthetic, i.e., the trihalomethane is chemically synthesized.

The trihalomethane may be produced by a recombinant yeast.

Bromoform may be obtained synthetically or from natural sources. For example, biological sources of organohalogen compounds such as bromoform are organohalogen-rich marine macroalgae. Species of marine macroalgae include Asparagopsis armata; Asparagopsis taxiformis; Dictyota species; Oedogonium species; Ulva species; and Cladophora patentiramea. The bromoform may be produced by bacteria, fungi and cyanobacteria. For example, bacteria include one Streptomyces sp. and Zobellia galactanivorans. For example, fungi include Pyricularia oryzae, Curvularia inaequalis, Pyrenophora tritici-repentis and Embellisia didymospora. For example, cyanobacteria include Trichodesmium erythraeum, Synechococcus sp. and Acaryochloris marina.

In other embodiments, the bromoform is synthetic, i.e., chemically synthesized.

In other embodiments, the bromoform may be produced by a recombinant yeast.

Iodoform may be obtained synthetically or from natural sources. For example, biological sources of organohalogen compounds such as bromoform are organohalogen-rich marine macroalgae. Species of marine macroalgae include Asparagopsis armata; Asparagopsis taxiformis; Dictyota species; Oedogonium species; Ulva species; and Cladophora patentiramea. The iodoform may be produced by bacteria, fungi and cyanobacteria. For example, bacteria include one Streptomyces sp. and Zobellia galactanivorans. For example, the fungi include one species of fungi selected from the group consisting of: Pyricularia oryzae, Curvularia inaequalis, Pyrenophora tritici-repentis, Embellisia didymospora, Agaricus species e.g. Agaricus angusticystidiatus; Agaricus iodoformicus Speg.; Agaricus moelleri; Agaricus phaeolepidotus; and Agaricus pseudochitonia, Mycena species e.g. Mycena pipterygia (Scop.: Fr.) Gray; and Mycena arcangeliana, Jahnoporus species e.g. Jahnoporus hirtus, Cortinarius species e.g. Cortinarius obtusus (Fr.) and Cortinarius seidlii, and Hemileccinum impolitum. For example, cyanobacteria include Trichodesmium erythraeum, Synechococcus sp. and Acaryochloris marina.

In other embodiments, the iodoform is synthetic, i.e., chemically synthesized.

In other embodiments, the iodoform may be produced by a recombinant yeast.

In some embodiments, the at least one other compound is a dibromochloromethane. This compound may be characterized as an organohalogen. It may be derived from natural products or synthesized.

In some embodiments, the at least one other compound is a dibromomethane. This compound may be characterized as an organohalogen. It may be derived from natural products or synthesized.

In some embodiments, the at least one other compound is selected from diallyl disulfide, diallyl trisulfide, dimethyl disulfide and dipropyl disulfide. These may be characterized as organosulfur compounds. They may be derived from natural products or synthesized. For example, the organosulfur compound may be obtained from garlic or another Allium species. For example, the organosulfur compound may be obtained from an extract of an Allium species such as garlic (Allium sativum).

In some embodiments, the at least one other compound is selected from prenylnaringenin (for example, 6-prenylnaringenin or 8-prenylnaringenin), bavachin, bavachinin, corylifol (for example, corylifol A or corylifol C), morusin, isobavachalcone, naringenin, quercetin and xanthohumol. These may be characterized as flavonoid/flavonoid like compounds. They may be derived from natural products or synthesized. In an embodiment, the prenylnaringenin is 8-prenylnaringenin. In another embodiment, the corylifol is corylifol A.

In some embodiments, the at least one other compound is tannic acid. This compound may be characterized as a polyphenol. It may be derived from natural products or synthesized.

In some embodiments, the at least one other compound is selected from cinnamon bark oil, garlic oil, sandalwood oil, thyme red oil, lemongrass oil and lemon verbena oil. These may be characterized as essential oils. They may be derived from natural products or synthesized.

In some embodiments, the at least one other compound is selected from carvacrol, citral, cinnamaldehyde and hexylcinnamaldehyde (for example, α-hexylcinnamaldehyde or 2-hexylcinnamaldehyde). These may be characterized as components of essential oils. They may be derived from natural products, in particular, from essential oils or synthesized. In an embodiment, the hexylcinnamaldehyde is α-hexylcinnamaldehyde.

In some embodiments, the at least one other compound is selected from sclareol, saikosaponin (for example, saikosaponin A, saikosaponin b2, saikosaponin C or saikosaponin D), ursolic acid and ginsenoside (for example, ginsenoside Rb1, ginsenoside Rb2, ginsenoside Rc, ginsenoside Rd, ginsenoside Re, ginsenoside Rg1 or ginsenoside Rf). These may be characterized as terpenes. These may be derived from natural products or synthesized. In an embodiment, the saikosaponin is saikosaponin b2. In another embodiment, the ginsenoside is ginsenoside Rb2.

In some embodiments, the at least one other compound is dibromoacetic acid. This may be characterized as a carboxylic acid. It may be derived from natural products or synthesized.

In some embodiments, the at least one other compound is 3-nitrooxypropanol. This may be characterized as a nitrooxy compound.

In some embodiments, the at least one other compound is pyromellitic diimide. This may be characterized as an arylene diimide.

### Ratio of Trihalomethane to the at Least One Other Compound(s)

In some embodiments, the ratio of the concentration of the trihalomethane other than dibromochloromethane to the at least one other compound is from about 1:0.05 to about 1:10,000. For example, in some embodiments, the ratio of trihalomethane to the at least one other compound is from about 1:0.05 to about from about 1:100, or from about 1:0.1 to about 1:75, or from about 1:0.1 to about 1:50. In some embodiments, the ratio of trihalomethane to the at least one other compound is from about 1:50 to about 1:9000, or from about 1:100 to about 1:9000, or from about 1:500 to about 1:9000, or from about 1:50 to about 1:100, or from about 1:100 to about 1:1000, or from about 1:100 to about 1:500, or from about 1:500 to about 1:1500, or from about 1:1000 to about 1:3000, or from about 1:10 to about 1:100, or about 1:1000 to about 1:3000, or from about 1:3000 to about 1:5000, or from about 1:7000 to about 1:9000, or from about 1:8000 to about 1:8500.

In some embodiments, the at least one other compound is dibromochloromethane and the ratio of the concentration of trihalomethane other than dibromochloromethane to dibromochloromethane is from about 1:1 to about 1:10, or from about 1:1 to about 1:5, or from about 1:1 to about 1:2, or about 1:1, or about 1:1.2, or about 1:1.3, or about 1:1.4, or about 1:1.5, or about 1:1.6, or about 1:1.7, or about 1:1.8, or about 1:1.9.

In some embodiments, the at least one other compound is dibromomethane and the ratio of the concentration of trihalomethane other than dibromochloromethane to dibromomethane is from about 1:0.05 to about 1:1, or about 1:0.1 to about 1:0.75, or from about 1:0.15 to about 1:0.5, or from about 1:0.2 to about 1:0.3.

In some embodiments, the at least one other compound is selected from diallyl disulfide, diallyl trisulfide, dimethyl disulfide and dipropyl disulfide and the ratio of the concentration of trihalomethane other than dibromochloromethane to said compound is from about 1:100 to about 1:10,000, for example, from about 1:500 to about 1:10,000, or from about 1:750 to about 1:1250, or from about 1:7500 to about 1:9000. In some embodiments, the at least one other compound is selected from diallyl disulfide, diallyl trisulfide, dimethyl disulfide and dipropyl disulfide and the ratio of the concentration of trihalomethane to said compound is from about 1:1 to about 1:100, or from about 1:5 to about 1:50, or from about 1:10 to about 1:25, or from about 1:10 to about 1:20.

In some embodiments, the at least one other compound is diallyl disulfide and the ratio of trihalomethane other than dibromochloromethane to said diallyl disulfide is from about 1:100 to about 1:3000, for example, from about 1:100 to about 1:2500, or from about 1:100 to about 1:2100. In some embodiments, the at least one other compound is diallyl disulfide and the ratio of trihalomethane to said diallyl disulfide is from about 1:1 to about 1:100, or from about 1:5 to about 1:50, or from about 1:10 to about 1:25, or from about 1:10 to about 1:20, or from about 1:10 to about 1:15.

In some embodiments, the at least one other compound is diallyl trisulfide and the ratio of the concentration of trihalomethane other than dibromochloromethane to said diallyl trisulfide is from about 1:500 to about 1:1500, for example, from about 1:750 to about 1:1250, or from about 1:1000 to about 1:1100. In some embodiments, the at least one other compound is diallyl trisulfide and the ratio of the concentration of trihalomethane to said diallyl trisulfide is from about 1:1 to about 1:100, or from about 1:5 to about 1:50, or from about 1:10 to about 1:25, or from about 1:10 to about 1:20, or from about 1:10 to about 1:15.

In some embodiments, the at least one other compound is dimethyl disulfide and the ratio of the concentration of trihalomethane other than dibromochloromethane to dimethyl disulfide is from about 1:7500 to 1:9000, for example, from about 1:8000 to 1:8500.

In some embodiments, the at least one other compound is dipropyl disulfide and the ratio of the concentration of trihalomethane other than dibromochloromethane to dipropyl disulfide is from about 1:7500 to about 1:9000, for example, from about 1:8000 to about 1:8500. In some embodiments, the at least one other compound is dipropyl disulfide and the ratio of the concentration of trihalomethane to dipropyl disulfide is from about 1:1 to about 1:100, or from about 1:5 to about 1:50, or from about 1:10 to about 1:25, or from about 1:12.5 to about 1:20, or from about 1:12.5 to about 1:17.5.

In some embodiments, the at least one other compound is selected from prenylnaringenin (for example, 6-prenylnaringenin or 8-prenylnaringenin), bavachin, bavachinin, corylifol (for example, corylifol A or corylifol C), morusin, isobavachalcone, naringenin, quercetin and xanthohumol and the ratio of the concentration of trihalomethane other than dibromochloromethane to said compound is from about 1:10 to about 1:1000, for example, from about 1:25 to about 1:1000, or from about 1:50 to about 1:100, of from about 1:50 to about 1:150. In some embodiments, the at least one other compound is selected from prenylnaringenin (for example, 6-prenylnaringenin or 8-prenylnaringenin), bavachin, bavachinin, corylifol (for example, corylifol A or corylifol C), morusin, isobavachalcone, naringenin, quercetin and xanthohumol and the ratio of the concentration of trihalomethane to said compound is from about 1:1 to about 1:500, or from about 1:5 to about 1:250, or from about 1:10 to about 1:100, or from about 1:25 to about 1:75.

In some embodiments, the at least one other compound is prenylnaringenin and the ratio of the concentration of trihalomethane other than dibromochloromethane to said compound is from about 1:50 to about 1:150, for example, from about 1:75 to about 1:125, or from about 1:100 to about 1:110. In an embodiment, the prenylnaringenin is 6-prenylnaringenin or 8-prenylnaringenin, preferably 8-prenylnaringenin.

In some embodiments, the at least one other compound is bavachin and the ratio of the concentration of trihalomethane other than dibromochloromethane to said compound is from about 1:100 to 1:300, for example, from about 1:150 to about 1:250, or from 1:190 to 1:210.

In some embodiments, the at least one other compound is bavachinin and the ratio of the concentration of trihalomethane other than dibromochloromethane to said compound is from about 1:50 to 1:1000, for example, from about 1:100 to about 1:850, or from 1:50 to 1:150, or from about 1:75 to about 1:125, or from about 1:100 to about 1:110.

In some embodiments, the at least one other compound is corylifol A or corylifol C and the ratio of the concentration of trihalomethane other than dibromochloromethane to said compound is from about 1:10 to about 1:50, for example, from about 1:15 to about 1:35, or from about 1:20 to about 1:30. In an embodiment, the at least one other compound is corylifol A.

In some embodiments, the at least one other compound is morusin and the ratio of the concentration of trihalomethane other than dibromochloromethane to said compound is from about 1:2 to about 1:100, for example, from about 1:5 to about 1:90, or from about 1:10 to about 1:90, or from about 1:10 about 1:30, or from about 1:15 to about 1:25.

In some embodiments, the at least one other compound is isobavachalcone and the ratio of the concentration of trihalomethane other than dibromochloromethane to said compound is from about 1:10 to about 1:100, for example, from about 1:15 to about 1:75, or from about 1:20 to about 1:60, or from about 1:40 about 1:60, or from about 1:45 to about 1:55.

In some embodiments, the at least one other compound is naringenin and the ratio of the concentration of trihalomethane other than dibromochloromethane to said compound is from about 1:500 to about 1:1500, for example, from about 1:650 to about 1:1000, or from about 1:750 to about 1:900, or from about 1:800 to about 1:850. In some embodiments, the at least one other compound is naringenin and the ratio of the concentration of trihalomethane to said compound is from about 1:1 to about 1:500, or from about 1:5 to about 1:250, or from about 1:10 to about 1:100, or from about 1:25 to about 1:75, or from about 1:40 to about 1:60.

In some embodiments, the at least one other compound is quercetin and the ratio of the concentration of trihalomethane other than dibromochloromethane to said compound is from about 1:100 to about 1:1500, for example, from about 1:250 to about 1:1000, or from about 1:350 to about 1:900, or from about 1:750 to about 1:1000, or from about 1:800 to about 1:850.

In some embodiments, the at least one other compound is xanthohumol and the ratio of the concentration of trihalomethane other than dibromochloromethane to said compound is from about 1:25 to about 1:150, for example, from about 1:40 to about 1:120, or from about 1:80 to about 1:120, or from about 1:100 about 1:110.

In some embodiments, the at least one other compound is tannic acid and the ratio of the concentration of trihalomethane other than dibromochloromethane to said compound is from about 1:500 to about 1:1500, for example, from about 1:750 to about 1:1000, or from about 1:800 to about 1:900, or from about 1:800 to about 1:850.

In some embodiments, the at least one other compound is selected from cinnamon bark oil, garlic oil, sandalwood oil, thyme red oil, lemongrass oil and lemon verbena oil and the ratio of the concentration of trihalomethane other than dibromochloromethane to the amount of said compound is from about 1:100 to about 1:10,000, for example, from about 1:200 to about 1:9000, or from about 1:500 to about 1:2500, or from about 1:3000 to about 1:5000, or from about 1:7500 to 1:10,000, or from about 1:200 to about 1:300. In some embodiments, the at least one other compound is selected from cinnamon bark oil, garlic oil, sandalwood oil, thyme red oil, lemongrass oil and lemon verbena oil and the ratio of the concentration of trihalomethane to the amount of said compound is from about 1:0.5 to about 1:100, or from about 1:1 to about 1:75, or from about 1:2.5 to about 1:50 or from about 1:5 to about 1:30.

In some embodiments, the at least one other compound is cinnamon bark oil and the ratio of the concentration of trihalomethane other than dibromochloromethane to the amount of said compound is from about 1:7500 to about 1:10,000, or from about 1:8000 to about 1:9000, or from about 1:8000 to about 1:8500.

In some embodiments, the at least one other compound is garlic oil and the ratio of the concentration of trihalomethane other than dibromochloromethane to the amount of said compound is from about 1:500 to about 1:4000, or from about 1:750 to about 1:3000, or from about 1:1000 to about 1:2500, or from about 1:1500 to about 1:2500, or from about 1:1750 to about 1:2250, or from about 1:2000 to about 1:2100. In some embodiments, the at least one other compound is garlic oil and the ratio of the concentration of trihalomethane to the amount of said compound is from about 1:0.5 to about 1:100, from about 1:1 to about 1:50, or from about 1:2.5 to about 1:25 or from about 1:5 to about 1:10.

In some embodiments, the at least one other compound is sandalwood oil and the ratio of the concentration of trihalomethane other than dibromochloromethane to the amount of said compound is from about 1:100 to about 1:500, or from about 1:200 to about 1:400, or from about 1:200 to about 1:300, or from about 1:250 to about 1:270.

In some embodiments, the at least one other compound is thyme red oil and the ratio of the concentration of trihalomethane other than dibromochloromethane to the amount of said compound is from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200. In some embodiments, the at least one other compound is thyme red oil and the ratio of the concentration of trihalomethane to the amount of said compound is from about 1:1 to about 1:100, from about 1:2.5 to about 1:75, or from about 1:5 to about 1:50 or from about 1:10 to about 1:40, is from about 1:20 to about 1:30.

In some embodiments, the at least one other compound is lemongrass oil and the ratio of the concentration of trihalomethane other than dibromochloromethane to the amount of said compound is from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200. In some embodiments, the at least one other compound is lemongrass oil and the ratio of the concentration of trihalomethane to the amount of said compound is from about 1:1 to about 1:100, from about 1:2.5 to about 1:75, or from about 1:5 to about 1:50 or from about 1:10 to about 1:40, is from about 1:20 to about 1:30.

In some embodiments, the at least one other compound is lemon verbena oil and the ratio of the concentration of trihalomethane other than dibromochloromethane to the amount of said compound is from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200.

In some embodiments, the at least one other compound is selected from carvacrol, citral, cinnamaldehyde and hexylcinnamaldehyde (for example, α-hexylcinnamaldehyde or 2-hexylcinnamaldehyde) and the ratio of the concentration of trihalomethane other than dibromochloromethane to said compound is from about 1:200 to about 1:10,000, for example, from about 1:200 to about 1:300, or from about 1:3000 to about 1:9000, or from about 1:3000 to about 1:5000, or from about 1:7500 to about 1:10,000. In some embodiments, the at least one other compound is selected from carvacrol, citral, cinnamaldehyde and hexylcinnamaldehyde (for example, α-hexylcinnamaldehyde or 2-hexylcinnamaldehyde) and the ratio of the concentration of trihalomethane to said compound is from about 1:1 to about 1:100, or from about 1:5 to about 1:50, or from about 1:10 to about 1:25, or from about 1:10 to about 1:20, or from about 1:10 to about 1:15.

In some embodiments, the at least one other compound is carvacrol and the ratio of the concentration of trihalomethane other than dibromochloromethane to said compound is from about from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200.

In some embodiments, the at least one other compound is citral and the ratio of the concentration of trihalomethane other than dibromochloromethane to said compound is from about from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200.

In some embodiments, the at least one other compound is cinnamaldehyde and the ratio of the concentration of trihalomethane other than dibromochloromethane to said compound is from about 1:7500 to about 1:10,000, or from about 1:8000 to about 1:9000, or from about 1:8000 to about 1:8500.

In some embodiments, the at least one other compound is hexylcinnamaldehyde (for example, α-hexylcinnamaldehyde or 2-hexylcinnamaldehyde) and the ratio of the concentration of trihalomethane other than dibromochloromethane to said compound is from about 1:100 to about 1:500, or from about 1:200 to about 1:400, or from about 1:200 to about 1:300, or from about 1:250 to about 1:270. In some embodiments, the at least one other compound is hexylcinnamaldehyde (for example, α-hexylcinnamaldehyde or 2-hexylcinnamaldehyde) and the ratio of the concentration of trihalomethane to said compound is from about 1:1 to about 1:100, or from about 1:5 to about 1:50, or from about 1:10 to about 1:25, or from about 1:10 to about 1:20, or from about 1:10 to about 1:15. In an embodiment, the at least one other compound is α-hexylcinnamaldehyde.

In some embodiments, the at least one other compound is selected from sclareol, saikosaponin (for example, saikosaponin A, saikosaponin b2, saikosaponin C or saikosaponin D), ursolic acid and ginsenoside (for example, ginsenoside Rb1, ginsenoside Rb2, ginsenoside Rc, ginsenoside Rd, ginsenoside Re, ginsenoside Rg1 or ginsenoside Rf) and the ratio of the concentration of trihalomethane other than dibromochloromethane to said compound is from about 1:50 to about 1:1000, or from about 1:50 to about 1:250, or from about 1:750 to about 1:900.

In some embodiments, the at least one other compound is sclareol and the ratio of the concentration of trihalomethane other than dibromochloromethane to said compound is from about 1:50 to about 1:500, or from about 1:100 to about 1:350, or from about 1:150 to about 1:250, or from about 1:175 to about 1:225.

In some embodiments, the at least one other compound is saikosaponin (for example, saikosaponin A, saikosaponin b2, saikosaponin C or saikosaponin D) and the ratio of the concentration of trihalomethane other than dibromochloromethane to said compound is from about 1:25 to about 1:150, or from about 1:50 to about 1:100, or from about 1:70 to about 1:90, or from about 1:80 to about 1:85. In an embodiment, the at least one other compound is saikosaponin b2.

In some embodiments, the at least one other compound is ursolic acid and the ratio of the concentration of trihalomethane other than dibromochloromethane to said compound is from about 1:500 to about 1:1500, for example, from about 1:750 to about 1:1000, or from about 1:800 to about 1:900, or from about 1:800 to about 1:850.

In some embodiments, the at least one other compound is ginsenoside (for example, ginsenoside Rb1, ginsenoside Rb2, ginsenoside Rc, ginsenoside Rd, ginsenoside Re, ginsenoside Rg1 or ginsenoside Rf) and the ratio of the concentration of trihalomethane other than dibromochloromethane to said compound is from about 1:50 to about 1:350, or from about 1:50 to about 1:250, or from about 1:100 to about 1:200, or from about 1:150 to about 1:175. In an embodiment, the at least one other compound is ginsenoside Rb2.

In some embodiments, the at least one other compound is dibromoacetic acid and the ratio of the concentration of trihalomethane other than dibromochloromethane to dibromoacetic acid is from about 1:1000 to about 1:2000, for example, from about 1:1500 to about 1:1750, or from about 1:1600 to about 1:1700.

In some embodiments, the at least one other compound is 3-nitrooxypropanol and the ratio of the concentration of trihalomethane other than dibromochloromethane to 3-nitrooxypropanol is from about 1:2 to about 1:20, for example, from about 1.5 to about 1:15, or from about 1:5 to about 1:10, or from about 1:6 to about 1:8.

In some embodiments, the at least one other compound is pyromellitic diimide and the ratio of concentration of the trihalomethane other than dibromochloromethane to pyromellitic diimide is from about 1:0.05 to about 1:25, or from about 1:0.1 to about 1:10, or from about 1:0.5 to about 1:5, or from about 1:1 to about 1:2.5.

In some embodiments the composition comprises a trihalomethane other than dibromochloromethane and at least two other compounds, for example a trihalomethane and two other compounds. In some embodiments, the composition comprises a trihalomethane other than dibromochloromethane and at least two other compounds selected from a group consisting of dibromomethane, pyromellitic diimide, naringenin, dipropyl disulfide, garlic oil, diallyl disulfide, diallyl trisulfide, hexylcinnamaldehyde (for example, α-hexylcinnamaldehyde), thyme red oil, lemongrass oil, and any combination thereof. In some embodiments, the composition comprises a trihalomethane other than dibromochloromethane, dibromomethane and one other compound selected from a group consisting of naringenin, dipropyl disulfide, garlic oil, diallyl disulfide, or diallyl trisulfide.

In some embodiments, the ratio of the concentration of the trihalomethane other than dibromochloromethane to the at least two other compounds is from about 1:0.05:1 to about 1:1:500. For example, in some embodiments, the ratio of the trihalomethane to the at least two other compounds is from about 1:0.05:1 to about 1:0.75:250, or from about 1:0.15:2 to about 1:0.5:100, or from about 1:0.2:5 to about 1:0.3:50.

In some embodiments, one of the at least two other compounds is dibromomethane and the ratio of the concentration of the trihalomethane other than dibromochloromethane to dibromomethane is from about 1:0.05 to about 1:1, or about 1:0.1 to about 1:0.75, or from about 1:0.15 to about 1:0.5, or from about 1:0.2 to about 1:0.3.

In some embodiments, one of the at least two other compounds is selected from diallyl disulfide, diallyl trisulfide, dimethyl disulfide and dipropyl disulfide and the ratio of the concentration of the trihalomethane other than dibromochloromethane to said compound is from about 1:1 to about 1:100, or from about 1:5 to about 1:50, or from about 1:10 to about 1:25, or from about 1:10 to about 1:20.

In some embodiments, one of the at least two other compounds is diallyl disulfide and the ratio of the trihalomethane other than dibromochloromethane to said diallyl disulfide is from about 1:1 to about 1:100, or from about 1:5 to about 1:50, or from about 1:10 to about 1:25, or from about 1:10 to about 1:20, or from about 1:10 to about 1:15.

In some embodiments, one of the at least two other compounds is diallyl trisulfide and the ratio of the concentration of the trihalomethane other than dibromochloromethane to said diallyl trisulfide is from about 1:1 to about 1:100, or from about 1:5 to about 1:50, or from about 1:10 to about 1:25, or from about 1:10 to about 1:20, or from about 1:10 to about 1:15.

In some embodiments, one of the at least two other compounds is dipropyl disulfide and the ratio of the concentration of the trihalomethane other than dibromochloromethane to dipropyl disulfide is from about 1:1 to about 1:100, or from about 1:5 to about 1:50, or from about 1:10 to about 1:25, or from about 1:12.5 to about 1:20, or from about 1:12.5 to about 1:17.5.

In some embodiments, one of the at least two other compounds is selected from prenylnaringenin (for example, 6-prenylnaringenin or 8-prenylnaringenin), bavachin, bavachinin, corylifol (for example, corylifol A or corylifol C), morusin, isobavachalcone, naringenin, quercetin and xanthohumol and the ratio of the concentration of the trihalomethane other than dibromochloromethane to said compound is from about 1:1 to about 1:500, or from about 1:5 to about 1:250, or from about 1:10 to about 1:100, or from about 1:25 to about 1:75.

In some embodiments, one of the at least two other compounds is naringenin and the ratio of the concentration of the trihalomethane other than dibromochloromethane to said compound is from about 1:1 to about 1:500, or from about 1:5 to about 1:250, or from about 1:10 to about 1:100, or from about 1:25 to about 1:75, or from about 1:40 to about 1:60.

In some embodiments, one of the at least two other compounds is selected from cinnamon bark oil, garlic oil, sandalwood oil, thyme red oil, lemongrass oil and lemon verbena oil and the ratio of the concentration of the trihalomethane other than dibromochloromethane to the amount of said compound is from about 1:0.5 to about 1:100, or from about 1:1 to about 1:75, or from about 1:2.5 to about 1:50 or from about 1:5 to about 1:30.

In some embodiments, one of the at least two other compounds is garlic oil and the ratio of the concentration of the trihalomethane other than dibromochloromethane to the amount of said compound is from about 1:0.5 to about 1:100, from about 1:1 to about 1:50, or from about 1:2.5 to about 1:25 or from about 1:5 to about 1:10.

In some embodiments, one of the at least two other compounds is thyme red oil and the ratio of the concentration of the trihalomethane other than dibromochloromethane to the amount of said compound is from about 1:1 to about 1:100, from about 1:2.5 to about 1:75, or from about 1:5 to about 1:50 or from about 1:10 to about 1:40, is from about 1:20 to about 1:30.

In some embodiments, one of the at least two other compounds is lemongrass oil and the ratio of the concentration of the trihalomethane other than dibromochloromethane to the amount of said compound is from about 1:1 to about 1:100, from about 1:2.5 to about 1:75, or from about 1:5 to about 1:50 or from about 1:10 to about 1:40, is from about 1:20 to about 1:30.

In some embodiments, one of the at least two other compounds is selected from carvacrol, citral, cinnamaldehyde and hexylcinnamaldehyde (for example, α-hexylcinnamaldehyde or 2-hexylcinnamaldehyde) and the ratio of the concentration of the trihalomethane other than dibromochloromethane to said compound is from about 1:1 to about 1:100, or from about 1:5 to about 1:50, or from about 1:10 to about 1:25, or from about 1:10 to about 1:20, or from about 1:10 to about 1:15.

In some embodiments, one of the at least two other compounds is hexylcinnamaldehyde (for example, α-hexylcinnamaldehyde or 2-hexylcinnamaldehyde) and the ratio of the concentration of the trihalomethane other than dibromochloromethane to said compound is from about 1:1 to about 1:100, or from about 1:5 to about 1:50, or from about 1:10 to about 1:25, or from about 1:10 to about 1:20, or from about 1:10 to about 1:15. In an embodiment, the at least one other compound is α-hexylcinnamaldehyde.

In some embodiments, one of the at least two other compounds is pyromellitic diimide and the ratio of concentration of the trihalomethane other than dibromochloromethane to pyromellitic diimide is from about 1:0.05 to about 1:25, or from about 1:0.1 to about 1:10, or from about 1:0.5 to about 1:5, or from about 1:1 to about 1:2.5

In some embodiments, the at least two other compounds are dibromomethane and diallyl disulfide and the concentration of the trihalomethane other than dibromochloromethane to dibromomethane to diallyl disulfide is from about 1:0.05:1 to about 1:1:50, or about 1:0.1:5 to about 1:0.75:25, or from about 1:0.15:10 to about 1:0.5:20, or from about 1:0.2:10 to about 1:0.3:15.

In some embodiments, the at least two other compounds are dibromomethane and diallyl trisulfide and the concentration of the trihalomethane other than dibromochloromethane to dibromomethane to diallyl trisulfide is from about 1:0.05:1 to about 1:1:50, or about 1:0.1:5 to about 1:0.75:25, or from about 1:0.15:10 to about 1:0.5:20, or from about 1:0.2:10 to about 1:0.3:15.

In some embodiments, the at least two other compounds are dibromomethane and dipropyl disulfide and the concentration of the trihalomethane other than dibromochloromethane to dibromomethane to dipropyl disulfide is from about 1:0.05:1 to about 1:1:50, or about 1:0.1:5 to about 1:0.75:25, or from about 1:0.15:10 to about 1:0.5:20, or from about 1:0.2:12.5 to about 1:0.3:17.5

In some embodiments, the at least two other compounds are dibromomethane and naringenin and the concentration of the trihalomethane other than dibromochloromethane to dibromomethane to naringenin is from about 1:0.05:5 to about 1:1:250, or about 1:0.1:10 to about 1:0.75:100, or from about 1:0.15:25 to about 1:0.5:75, or from about 1:0.2:40 to about 1:0.3:60.

In some embodiments, the at least two other compounds are dibromomethane and garlic oil and the concentration of iodoform to dibromomethane to garlic oil is from about 1:0.05:0.5 to about 1:1:100, or about 1:0.1:1 to about 1:0.75:50, or from about 1:0.15:2.5 to about 1:0.5:25, or from about 1:0.2:5 to about 1:0.3:10.

In some embodiments, the concentration of trihalomethane other than dibromochloromethane in the composition is less than 0.30 μM, for example, less than 0.25 μM, or less than 0.20 μM, or less than 0.15 μM. In some embodiments, the concentration of trihalomethane in the composition is at least about 0.05 M, for example, at least about 0.075 μM, or at least about 0.10 μM. In some embodiments, the concentration is from about 0.05 μM to about 0.20 μM, for example, from about 0.075 μM to about 0.175 μM, or from about 0.10 μM to about 0.15 μM, or from about 0.11 μM to about 0.13 μM. In some embodiments the concentration of trihalomethane in the composition is less than 25 μM, or less than 20 μM, or less than 15 μM, or less than 10 μM, or less than 5 μM or less than 2.5 M. In some embodiments, the concentration of trihalomethane other than dibromochloromethane in the composition is at least about 0.5 μM, for example, at least about 1 μM, or at least about 2 μM, or at least about 5 μM, or at least about 10 μM. In some embodiments, the concentration is from about 0.5 μM to about 50 μM, or from about 1 μM to about 25 μM, or from about 1.5 μM to about 12.5 μM.

In some embodiments, the concentration of the at least one other compound is at least about 0.5 μM, at least about 2.0 μM, for example, at least about 10.0 M, or at least about 50.0 μM, or at least about 100.0 μM, or at least about 250.0 μM, or at least about 500.0 μM, or at least about 750.0 μM. In some embodiments, the concentration of the at least one other compound is less than about 5.0 mM, for example, less than about 2.5 mM, or less than about 1.0 mM, or less than about 750.0 μM, or less than about 500.0 μM, or less than about 250.0 μM, or less than about 100.0 μM, or less than about 50 μM, or less than about 10 μM, or less than about 5 μM.

In some embodiments, the concentration of the at least one other compound in the composition is from about 0.15 μM to about 1.0 mM, for example, from about 0.5 μM to about 1.0 mM, or from about 2.0 μM to about 750.0 M, or from about 2.0 μM to about 500.0 μM, or from about 2.0 μM to about 250.0 μM, or from about 2.0 μM to about 150.0 μM, or from about 2.0 μM to about 100.0 μM.

In some embodiments, the at least one other compound is dibromochloromethane and the concentration of dibromochloromethane in the composition is from about 0.15 μM to about 1.0 μM, for example, from about 0.15 μM to about 0.5 μM, or from about 0.15 μM to about 0.25 μM.

In some embodiments, the at least one other compound is dibromomethane and the concentration of dibromomethane in the composition is from about 0.05 μM to about 50 μM, or from about 0.1 μM to about 25 μM, or from about 0.25 μM to about 12.5 M.

In some embodiments, the at least one other compound is diallyl disulfide and the concentration of diallyl disulfide in the composition is from about 5.0 μM to about 500.0 μM, for example, from about 10.0 μM to about 350.0 μM, or from about 15.0 μM to about 250.0 μM. In some embodiments, the at least one other compound is diallyl disulfide and the concentration of diallyl disulfide in the composition is from about 0.1 μM to about 100.0 μM, or from about 0.5 μM to about 75.0 μM, or from about 1.0 μM to about 50.0 μM, or from about 5.0 M to about 40.0 μM, or from about 15.0 μM to about 30.0 μM.

In some embodiments, the at least one other compound is diallyl trisulfide and the concentration of diallyl trisulfide in the composition is from about 50.0 μM to about 250.0 μM, for example, from about 75.0 μM to about 200.0 μM, or from about 100.0 μM to about 150.0 μM. In some embodiments, the at least one other compound is diallyl trisulfide and the concentration of diallyl trisulfide in the composition is from about 0.1 μM to about 100.0 μM, or from about 0.5 μM to about 75.0 M, or from about 1.0 μM to about 50.0 μM, or from about 5.0 μM to about 40.0 μM, or from about 15.0 μM to about 30.0 M.

In some embodiments, the at least one other compound is dimethyl disulfide and the concentration of dimethyl disulfide in the composition is from about 500.0 μM to about 1.5 mM, for example, from about 750 μM to about 1.25 mM, or from about 900.0 μM to about 1.1 mM.

In some embodiments, the at least one other compound is dipropyl disulfide and the concentration of dipropyl disulfide in the composition is from about 500.0 μM to about 1.5 mM, for example, from about 750.0 μM to about 1.25 mM, or from about 900.0 μM to about 1.1 mM. In some embodiments, the at least one other compound is dipropyl disulfide and the concentration of dipropyl disulfide in the composition is from about 0.5 M to about 100.0 μM, or from about 1.0 μM to about 80.0 μM, or from about 5.0 μM to about 60.0 μM, or from about 10.0 μM to about 50.0 μM, or from about 15.0 μM to about 40.0 μM, or from about 20.0 μM to about 40.0 μM.

In some embodiments, the at least one other compound is prenylnaringenin (for example, 6-prenylnaringenin or 8-prenylnaringenin) and the concentration of prenylnaringenin in the composition is from about 2.0 μM to about 50.0 μM, for example, from about 5.0 μM to about 25.0 μM, or from about 10.0 μM to about 15.0 μM. In an embodiment, the prenylnaringenin is 8 -prenylnaringenin.

In some embodiments, the at least one other compound is bavachin and the concentration of bavachin in the composition is from about 5.0 μM to about 75.0 μM, for example, from about 10.0 μM to about 50.0 μM, or from about 15.0 μM to about 35.0 μM, or from about 20.0 μM to about 30.0 μM.

In some embodiments, the at least one other compound is bavachinin and the concentration of bavachinin in the composition is from about 2.0 μM to about 200.0 μM, for example, from about 5.0 μM to about 150.0 M, or from about 10.0 M to about 125.0 μM.

In some embodiments, the at least one other compound is corylifol A or corylifol C and the concentration of corylifol A or corylifol C in the composition is from about 0.5 μM to about 10.0 μM, for example, from about 1.0 μM to about 7.5 μM, or from about 2.0 μM to about 5.0 μM. In an embodiment, the at least one other compound is corylifol A.

In some embodiments, the at least one other compound is morusin and the concentration of morusin in the composition is from about 0.25 μM to about 50.0 μM, for example, from about 0.50 μM to about 25.0 μM, or from about 1.0 μM to about 15.0 μM.

In some embodiments, the at least one other compound is isobavachalone and the concentration of isobavachalone in the composition is from about 1.0 μM to about 15.0 μM, for example, from about 2.5 M to about 12.5 μM, or from about 4.0 μM to about 10.0 μM, or from about 5.0 μM to about 7.5 μM.

In some embodiments, the at least one other compound is naringenin and the concentration of naringenin in the composition is from about 25.0 μM to about 250.0 μM, for example, from about 50.0 μM to about 150.0 μM, or from about 75.0 μM to about 125.0 μM, or from about 90.0 μM to about 110.0 μM.

In some embodiments, the at least one other compound is quercetin and the concentration of quercetin in the composition is from about 25.0 μM to about 250.0 μM, for example, from about 50.0 μM to about 150.0 μM, or from about 75.0 μM to about 125.0 μM, or from about 90.0 μM to about 110.0 μM.

In some embodiments, the at least one other compound is xanthohumol and the concentration of xanthohumol in the composition is from about 2.0 M to about 50.0 μM, for example, from about 5.0 μM to about 25.0 μM, or from about 10.0 μM to about 15.0 μM.

In some embodiments, the at least one other compound is tannic acid and the concentration of tannic acid in the composition is from about 25.0 μM to about 250.0 μM, for example, from about 50.0 μM to about 150.0 μM, or from about 75.0 μM to about 125.0 μM, or from about 90.0 μM to about 110.0 μM.

In some embodiments, the at least one other compound is carvacrol and the concentration of carvacrol in the composition is from about 250.0 μM to about 1.0 mM, for example, from about 250 μM to about 750.0 μM, or from about 400.0 μM to about 600.0 μM, or from about 450.0 μM to about 550.0 μM.

In some embodiments, the at least one other compound is citral and the concentration of citral in the composition is from about 250.0 μM to about 1.0 mM, for example, from about 250 μM to about 750.0 μM, or from about 400.0 μM to about 600.0 μM, or from about 450.0 μM to about 550.0 μM.

In some embodiments, the at least one other compound is cinnamaldehyde and the concentration of cinnamaldehyde in the composition is from about 500.0 μM to about 1.5 mM, for example, from about 750 μM to about 1.25 mM, or from about 900.0 μM to about 1.1 mM.

In some embodiments, the at least one other compound is hexylcinnamaldehyde (for example, α-hexylcinnamaldehyde or 2-hexylcinnamaldehyde) of and the concentration hexylcinnamaldehyde in the composition is from about 10.0 μM to about 75.0 μM, for example, from about 15.0 μM to about 50.0 μM, or from about 20.0 μM to about 40.0 μM, or from about 25.0 μM to about 35.0 μM. In an embodiment, the at least one other compound is α-hexylcinnamaldehyde.

In some embodiments, the at least one other compound is sclareol and the concentration of sclareol in the composition is from about 5.0 μM to about 75.0 μM, for example, from about 10.0 μM to about 50.0 μM, or from about 15.0 μM to about 35.0 μM, or from about 20.0 μM to about 30.0 μM.

In some embodiments, the at least one other compound is saikosaponin (for example, saikosaponin A, saikosaponin b2, saikosaponin C or saikosaponin D) and the concentration of saikosaponin in the composition is from about 2.0 μM to about 25.0 μM, for example, from about 5.0 μM to about 15.0 μM, or from about 8.0 μM to about 12.0 μM. In an embodiment, the at least one other compound is saikosaponin b2.

In some embodiments, the at least one other compound is ursolic acid and the concentration of ursolic acid in the composition is from about 25.0 μM to about 250.0 μM, for example, from about 50.0 μM to about 150.0 μM, or from about 75.0 μM to about 125.0 μM, or from about 90.0 μM to about 110.0 μM.

In some embodiments, the at least one other compound is ginsenoside (for example, ginsenoside Rb1, ginsenoside Rb2, ginsenoside Rc, ginsenoside Rd, ginsenoside Re, ginsenoside Rg1 or ginsenoside Rf) and the concentration of ginsenoside in the composition is from about 5.0 μM to about 50.0 μM, for example, from about 10.0 μM to about 40.0 μM, or from about 15.0 μM to about 30.0 μM, or from about 15.0 μM to about 25.0 μM. In an embodiment, the at least one other compound is ginsenoside Rb2.

In some embodiments, the at least one other compound is dibromoacetic acid and the concentration of dibromoacetic acid in the composition is from about 50.0 μM to about 500.0 μM, for example, from about 100.0 μM to about 350.0 μM, or from about 150.0 μM to about 250.0 μM, or from about 175.0 μM to about 225.0 M.

In some embodiments, the at least one other compound is 3-nitrooxypropanol and the concentration of 3-nitrooxypropanol in the composition is from about 0.25 μM to about 4.0 μM, for example, from about 0.50 μM to about 2.5 μM, or from about 0.50 μM to about 1.75 μM, or from about 0.50 μM to about 1.5 μM, or from about 0.50 μM to about 1.0 μM, or from about 0.70 μM to about 0.85 μM.

In some embodiments, the at least one other compound is cinnamon bark oil and the amount of cinnamon bark oil in the composition is from about 100 ppm to about 500 ppm, for example, from about 150 ppm to about 350 ppm, or from about 200 ppm to about 300 ppm, or from about 225 ppm to about 275 ppm.

In some embodiments, the at least one other compound is garlic oil and the amount of garlic oil in the composition is from about 10 ppm to about 250 ppm, for example, from about 25 ppm to about 150 ppm, or from about 40 ppm to about 100 ppm, or from about 50 ppm to about 75 ppm. In some embodiments, the at least one other compound is garlic oil and the amount of garlic oil in the composition is from about 0.5 ppm, or is from about 1 ppm, or is from about 2 ppm, or is from about 3 ppm, or is from about 4 ppm, or is from about 5 ppm.

In some embodiments, the at least one other compound is sandalwood oil and the amount of sandalwood oil in the composition is from about 1 ppm to about 20 ppm, for example, from about 3 ppm to about 15 ppm, or from about 4 ppm to about 10 ppm, or from about 6 ppm to about 8 ppm, or from about 7 ppm to about 8 ppm.

In some embodiments, the at least one other compound is thyme red oil and the amount of thyme red oil in the composition is from about 10 ppm to about 250 ppm, for example, from about 50 ppm to about 200 ppm, or from about 75 ppm to about 150 ppm, or from about 100 ppm to about 150 ppm. In some embodiments, the at least one other compound is thyme red oil and the amount of thyme red oil in the composition is from about 0.5 ppm to about 50 ppm, or is from about 1 ppm to about 40 ppm, or is from about 5 ppm to about 35 ppm, or is from about 10 ppm to about 30 ppm, or is from about 15 ppm to about 25 ppm.

In some embodiments, the at least one other compound is lemongrass oil and the amount of lemongrass oil in the composition is from about 10 ppm to about 250 ppm, for example, from about 50 ppm to about 200 ppm, or from about 75 ppm to about 150 ppm, or from about 100 ppm to about 150 ppm. In some embodiments, the at least one other compound is lemongrass oil and the amount of lemongrass oil in the composition is from about 0.5 ppm to about 50 ppm, or is from about 1 ppm to about 40 ppm, or is from about 5 ppm to about 35 ppm, or is from about 10 ppm to about 30 ppm, or is from about 15 ppm to about 25 ppm.

In some embodiments, the at least one other compound is lemon verbena oil and the amount of lemon verbena oil in the composition is from about 10 ppm to about 250 ppm, for example, from about 50 ppm to about 200 ppm, or from about 75 ppm to about 150 ppm, or from about 100 ppm to about 150 ppm.

In some embodiments, the at least one other compound is pyromellitic diimide and the amount of pyromellitic diimide in the composition is from about 0.1 ppm to about 10 ppm, or from about 0.25 ppm to about 7.5 ppm, or from about 0.5 to about 5 ppm, or from about 0.75 ppm to about 2.5 ppm.

In some embodiments, one of the at least two other compounds is dibromomethane and the concentration of dibromomethane in the composition is from about 0.05 μM to about 50 μM, or from about 0.1 μM to about 25 μM, or from about 0.25 μM to about 12.5 μM. In some embodiments the concentration of dibromomethane is from about 0.1 μM to about 1 μM, for example from about 0.25 μM to about 0.75 μM.

In some embodiments, one of the at least two other compounds is diallyl disulfide and the concentration of diallyl disulfide in the composition is from about 0.1 μM to about 100 μM, or from about 0.5 μM to about 75 μM, or from about 1.0 μM to about 50 μM, or from about 5.0 μM to about 40 μM, or from about 15 μM to about 30 μM.

In some embodiments, one of the at least two other compounds is diallyl trisulfide and the concentration of diallyl trisulfide in the composition is from about 0.1 μM to about 100 μM, or from about 0.5 μM to about 75 μM, or from about 1.0 μM to about 50 μM, or from about 5.0 μM to about 40 μM, or from about 15 μM to about 30 μM.

In some embodiments, one of the at least two other compounds is dipropyl disulfide and the concentration of dipropyl disulfide in the composition is from about 0.5 μM to about 100 μM, or from about 1.0 μM to about 80 μM, or from about 5.0 μM to about 60 μM, or from about 10 μM to about 50 μM, or from about 15 μM to about 40 M, or from about 20 μM to about 40 μM.

In some embodiments, one of the at least two other compounds is naringenin and the concentration of naringenin in the composition is from about 25 μM to about 250 μM, for example, from about 50 μM to about 150 μM, or from about 75 μM to about 125 μM, or from about 90 μM to about 110 μM.

In some embodiments, one of the at least two other compounds is hexylcinnamaldehyde (for example, α-hexylcinnamaldehyde or 2-hexylcinnamaldehyde) and the concentration of hexylcinnamaldehyde in the composition is from about 10 μM to about 75 M, for example, from about 15 μM to about 50 μM, or from about 20 μM to about 40 μM, or from about 25 μM to about 35 μM. In an embodiment, the at least one other compound is α-hexylcinnamaldehyde.

In some embodiments, one of the at least two other compounds is garlic oil and the amount of garlic oil in the composition is from about 0.5 ppm, or is from about 1 ppm, or is from about 2 ppm, or is from about 3 ppm, or is from about 4 ppm, or is from about 5 ppm.

In some embodiments, one of the at least two other compounds is thyme red oil and the amount of thyme red oil in the composition is from about 0.5 ppm to about 50 ppm, or is from about 1 ppm to about 40 ppm, or is from about 5 ppm to about 35 ppm, or is from about 10 ppm to about 30 ppm, or is from about 15 ppm to about 25 ppm.

In some embodiments, one of the at least two other compounds is lemongrass oil and the amount of lemongrass oil in the composition is from about 0.5 ppm to about 50 ppm, or is from about 1 ppm to about 40 ppm, or is from about 5 ppm to about 35 ppm, or is from about 10 ppm to about 30 ppm, or is from about 15 ppm to about 25 ppm.

In some embodiments, one of the at least two other compounds is pyromellitic diimide and the amount of pyromellitic diimide in the composition is from about 0.1 ppm to about 10 ppm, or from about 0.25 ppm to about 7.5 ppm, or from about 0.5 to about 5 ppm, or from about 0.75 ppm to about 2.5 ppm.

In some embodiments, the at least two other compounds are dibromomethane and diallyl disulfide, and the concentration of the trihalomethane other than dibromochloromethane in the composition is from about 0.5 μM to about 10 μM, or from about 1 μM to about 5 μM, or from about 1.5 μM to about 2.5 μM; the concentration of dibromomethane is from about 0.1 μM to about 1 μM, for example from about 0.25 M to about 0.75 μM; and the concentration of diallyl disulfide is from about 1.0 μM to about 50 μM, or from about 5.0 μM to about 40 μM, or from about 15 μM to about 30 μM, or from about 20 M to about 30 μM.

In some embodiments, the at least two other compounds are dibromomethane and diallyl trisulfide, and the concentration of the trihalomethane other than dibromochloromethane in the composition is from about 0.5 μM to about 10 μM, or from about 1 μM to about 5 μM, or from about 1.5 μM to about 2.5 μM; the concentration of dibromomethane is from about 0.1 μM to about 1 μM, for example from about 0.25 μM to about 0.75 μM; and the concentration of diallyl trisulfide is from about 1.0 μM to about 50 μM, or from about 5.0 μM to about 40 μM, or from about 15 μM to about 30 μM, or from about 20 μM to about 30 μM.

In some embodiments, the at least two other compounds are dibromomethane and dipropyl disulfide, and the concentration of the trihalomethane other than dibromochloromethane in the composition is from about 0.5 μM to about 10 μM, or from about 1 μM to about 5 μM, or from about 1.5 μM to about 2.5 μM; the concentration of dibromomethane is from about 0.1 μM to about 1 μM, for example from about 0.25 μM to about 0.75 μM; and the concentration of dipropyl disulfide is from about 10 μM to about 50 μM, or from about 15 μM to about 40 μM, or from about 20 μM to about 40 μM

In some embodiments, the at least two other compounds are dibromomethane and naringenin, and the concentration of the trihalomethane other than dibromochloromethane in the composition is from about 0.5 μM to about 10 μM, or from about 1 μM to about 5 μM, or from about 1.5 μM to about 2.5 μM; the concentration of dibromomethane is from about 0.1 μM to about 1 μM, for example from about 0.25 μM to about 0.75 μM; and the concentration of naringenin is from about 50 μM to about 150 μM, or from about 75 μM to about 125 μM, or from about 90 μM to about 110 μM.

In some embodiments, the at least two other compounds are dibromomethane and garlic oil, and the concentration of the trihalomethane other than dibromochloromethane in the composition is from about 0.5 μM to about 10 μM, or from about 1 μM to about 5 μM, or from about 1.5 μM to about 2.5 μM; the concentration of dibromomethane is from about 0.1 μM to about 1 μM, for example from about 0.25 μM to about 0.75 μM; and the amount of garlic oil is from about 1 ppm, or is from about 2 ppm, or is from about 3 ppm, or is from about 4 ppm, or is from about 5 ppm.

### Ratio of Bromoform to the at Least One Other Compound(s)

In some embodiments, the ratio of the concentration of bromoform to the at least one other compound is from about 1:1 to about 1:10,000. For example, in some embodiment, the ratio of bromoform to the at least one other compound is from about 1:50 to about 1:9000, or from about 1:100 to about 1:9000, or from about 1:500 to about 1:9000, or from about 1:50 to about 1:100, or from about 1:100 to about 1:1000, or from about 1:100 to about 1:500, or from about 1:500 to about 1:1500, or from about 1:1000 to about 1:3000, or from about 1:10 to about 1:100, or about 1:1000 to about 1:3000, or from about 1:3000 to about 1:5000, or from about 1:7000 to about 1:9000, or from about 1:8000 to about 1:8500.

In some embodiments, the at least one other compound is dibromochloromethane and the ratio of the concentration of bromoform to dibromochloromethane is from about 1:1 to about 1:10, or from about 1:1 to about 1:5, or from about 1:1 to about 1:2, or about 1:1, or about 1:1.2, or about 1:1.3, or about 1:1.4, or about 1:1.5, or about 1:1.6, or about 1:1.7, or about 1:1.8, or about 1:1.9.

In some embodiments, the at least one other compound is selected from diallyl disulfide, diallyl trisulfide, dimethyl disulfide and dipropyl disulfide and the ratio of the concentration of bromoform to said compound is from about 1:100 to about 1:10,000, for example, from about 1:500 to about 1:10,000, or from about 1:750 to about 1:1250, or from about 1:7500 to about 1:9000.

In some embodiments, the at least one other compound is diallyl disulfide and the ratio of bromoform to said diallyl disulfide is from about 1:100 to about 1:3000, for example, from about 1:100 to about 1:2500, or from about 1:100 to about 1:2100.

In some embodiments, the at least one other compound is diallyl trisulfide and the ratio of the concentration of bromoform to said diallyl trisulfide is from about 1:500 to about 1:1500, for example, from about 1:750 to about 1:1250, or from about 1:1000 to about 1:1100.

In some embodiments, the at least one other compound is dimethyl disulfide and the ratio of the concentration of bromoform to dimethyl disulfide is from about 1:7500 to 1:9000, for example, from about 1:8000 to 1:8500.

In some embodiments, the at least one other compound is dipropyl disulfide and the ratio of the concentration of bromoform to dipropyl disulfide is from about 1:7500 to about 1:9000, for example, from about 1:8000 to about 1:8500.

In some embodiments, the at least one other compound is selected from prenylnaringenin (for example, 6-prenylnaringenin or 8-prenylnaringenin), bavachin, bavachinin, corylifol (for example, corylifol A or corylifol C), morusin, isobavachalcone, naringenin, quercetin and xanthohumol and the ratio of the concentration of bromoform to said compound is from about 1:10 to about 1:1000, for example, from about 1:25 to about 1:1000, or from about 1:50 to about 1:100, of from about 1:50 to about 1:150.

In some embodiments, the at least one other compound is prenylnaringenin and the ratio of the concentration of bromoform to said compound is from about 1:50 to about 1:150, for example, from about 1:75 to about 1:125, or from about 1:100 to about 1:110. In an embodiment, the prenylnaringenin is 6-prenylnaringenin or 8-prenylnaringenin, preferably 8-prenylnaringenin.

In some embodiments, the at least one other compound is bavachin and the ratio of the concentration of bromoform to said compound is from about 1:100 to 1:300, for example, from about 1:150 to about 1:250, or from 1:190 to 1:210.

In some embodiments, the at least one other compound is bavachinin and the ratio of the concentration of bromoform to said compound is from about 1:50 to 1:1000, for example, from about 1:100 to about 1:850, or from 1:50 to 1:150, or from about 1:75 to about 1:125, or from about 1:100 to about 1:110.

In some embodiments, the at least one other compound is corylifol A or corylifol C and the ratio of the concentration of bromoform to said compound is from about 1:10 to about 1:50, for example, from about 1:15 to about 1:35, or from about 1:20 to about 1:30. In an embodiment, the at least one other compound is corylifol A.

In some embodiments, the at least one other compound is morusin and the ratio of the concentration of bromoform to said compound is from about 1:2 to about 1:100, for example, from about 1:5 to about 1:90, or from about 1:10 to about 1:90, or from about 1:10 about 1:30, or from about 1:15 to about 1:25.

In some embodiments, the at least one other compound is isobavachalcone and the ratio of the concentration of bromoform to said compound is from about 1:10 to about 1:100, for example, from about 1:15 to about 1:75, or from about 1:20 to about 1:60, or from about 1:40 about 1:60, or from about 1:45 to about 1:55.

In some embodiments, the at least one other compound is naringenin and the ratio of the concentration of bromoform to said compound is from about 1:500 to about 1:1500, for example, from about 1:650 to about 1:1000, or from about 1:750 to about 1:900, or from about 1:800 to about 1:850.

In some embodiments, the at least one other compound is quercetin and the ratio of the concentration of bromoform to said compound is from about 1:100 to about 1:1500, for example, from about 1:250 to about 1:1000, or from about 1:350 to about 1:900, or from about 1:750 to about 1:1000, or from about 1:800 to about 1:850.

In some embodiments, the at least one other compound is xanthohumol and the ratio of the concentration of bromoform to said compound is from about 1:25 to about 1:150, for example, from about 1:40 to about 1:120, or from about 1:80 to about 1:120, or from about 1:100 about 1:110.

In some embodiments, the at least one other compound is tannic acid and the ratio of the concentration of bromoform to said compound is from about 1:500 to about 1:1500, for example, from about 1:750 to about 1:1000, or from about 1:800 to about 1:900, or from about 1:800 to about 1:850.

In some embodiments, the at least one other compound is selected from cinnamon bark oil, garlic oil, sandalwood oil, thyme red oil, lemongrass oil and lemon verbena oil and the ratio of the concentration of bromoform to the amount of said compound is from about 1:100 to about 1:10,000, for example, from about 1:200 to about 1:9000, or from about 1:500 to about 1:2500, or from about 1:3000 to about 1:5000, or from about 1:7500 to 1:10,000, or from about 1:200 to about 1:300.

In some embodiments, the at least one other compound is cinnamon bark oil and the ratio of the concentration of bromoform to the amount of said compound is from about 1:7500 to about 1:10,000, or from about 1:8000 to about 1:9000, or from about 1:8000 to about 1:8500.

In some embodiments, the at least one other compound is garlic oil and the ratio of the concentration of bromoform to the amount of said compound is from about 1:500 to about 1:4000, or from about 1:750 to about 1:3000, or from about 1:1000 to about 1:2500, or from about 1:1500 to about 1:2500, or from about 1:1750 to about 1:2250, or from about 1:2000 to about 1:2100.

In some embodiments, the at least one other compound is sandalwood oil and the ratio of the concentration of bromoform to the amount of said compound is from about 1:100 to about 1:500, or from about 1:200 to about 1:400, or from about 1:200 to about 1:300, or from about 1:250 to about 1:270.

In some embodiments, the at least one other compound is thyme red oil and the ratio of the concentration of bromoform to the amount of said compound is from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200.

In some embodiments, the at least one other compound is lemongrass oil and the ratio of the concentration of bromoform to the amount of said compound is from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200.

In some embodiments, the at least one other compound is lemon verbena oil and the ratio of the concentration of bromoform to the amount of said compound is from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200.

In some embodiments, the at least one other compound is selected from carvacrol, citral, cinnamaldehyde and hexylcinnamaldehyde (for example, α-hexylcinnamaldehyde or 2-hexylcinnamaldehyde) and the ratio of the concentration of bromoform to said compound is from about 1:200 to about 1:10,000, for example, from about 1:200 to about 1:300, or from about 1:3000 to about 1:9000, or from about 1:3000 to about 1:5000, or from about 1:7500 to about 1:10,000.

In some embodiments, the at least one other compound is carvacrol and the ratio of the concentration of bromoform to said compound is from about from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200.

In some embodiments, the at least one other compound is citral and the ratio of the concentration of bromoform to said compound is from about from about 1:2500 to about 1:7500, or from about 1:3000 to about 1:5000, or from about 1:3750 to about 1:4500, or from about 1:4000 to about 1:4500, or from about 1:4100 to about 1:4250, or from about 1:4100 to about 1:4200.

In some embodiments, the at least one other compound is cinnamaldehyde and the ratio of the concentration of bromoform to said compound is from about 1:7500 to about 1:10,000, or from about 1:8000 to about 1:9000, or from about 1:8000 to about 1:8500.

In some embodiments, the at least one other compound is hexylcinnamaldehyde (for example, α-hexylcinnamaldehyde or 2-hexylcinnamaldehyde) and the ratio of the concentration of bromoform to said compound is from about 1:100 to about 1:500, or from about 1:200 to about 1:400, or from about 1:200 to about 1:300, or from about 1:250 to about 1:270. In an embodiment, the at least one other compound is α-hexylcinnamaldehyde.

In some embodiments, the at least one other compound is selected from sclareol, saikosaponin (for example, saikosaponin A, saikosaponin b2, saikosaponin C or saikosaponin D), ursolic acid and ginsenoside (for example, ginsenoside Rb1, ginsenoside Rb2, ginsenoside Rc, ginsenoside Rd, ginsenoside Re, ginsenoside Rg1 or ginsenoside Rf) and the ratio of the concentration of bromoform to said compound is from about 1:50 to about 1:1000, or from about 1:50 to about 1:250, or from about 1:750 to about 1:900.

In some embodiments, the at least one other compound is sclareol and the ratio of the concentration of bromoform to said compound is from about 1:50 to about 1:500, or from about 1:100 to about 1:350, or from about 1:150 to about 1:250, or from about 1:175 to about 1:225.

In some embodiments, the at least one other compound is saikosaponin (for example, saikosaponin A, saikosaponin b2, saikosaponin C or saikosaponin D) and the ratio of the concentration of bromoform to said compound is from about 1:25 to about 1:150, or from about 1:50 to about 1:100, or from about 1:70 to about 1:90, or from about 1:80 to about 1:85. In an embodiment, the at least one other compound is saikosaponin b2.

In some embodiments, the at least one other compound is ursolic acid and the ratio of the concentration of bromoform to said compound is from about 1:500 to about 1:1500, for example, from about 1:750 to about 1:1000, or from about 1:800 to about 1:900, or from about 1:800 to about 1:850.

In some embodiments, the at least one other compound is ginsenoside (for example, ginsenoside Rb1, ginsenoside Rb2, ginsenoside Rc, ginsenoside Rd, ginsenoside Re, ginsenoside Rg1 or ginsenoside Rf) and the ratio of the concentration of bromoform to said compound is from about 1:50 to about 1:350, or from about 1:50 to about 1:250, or from about 1:100 to about 1:200, or from about 1:150 to about 1:175. In an embodiment, the at least one other compound is ginsenoside Rb2.

In some embodiments, the at least one other compound is dibromoacetic acid and the ratio of the concentration of bromoform to dibromoacetic acid is from about 1:1000 to about 1:2000, for example, from about 1:1500 to about 1:1750, or from about 1:1600 to about 1:1700.

In some embodiments, the at least one other compound is 3-nitrooxypropanol and the ratio of the concentration of bromoform to 3-nitrooxypropanol is from about 1:2 to about 1:20, for example, from about 1.5 to about 1:15, or from about 1:5 to about 1:10, or from about 1:6 to about 1:8.

Bromoform is generally unstable in relatively high concentrations and potentially toxic at such concentrations, it is advantageous to obtain efficacy in reducing methane production at the lowest concentration possible. In accordance with the present invention, this is achievable for bromoform provided it is used in combination with the at least one other compound described herein. In fact, as demonstrated in the examples at very low concentrations, bromoform on its own does not reduce or inhibit methane production. However, when combined at such low concentrations with the at least one other compound as described herein reduction or inhibition of methane production is achievable.

In some embodiments, the concentration of bromoform in the composition is less than 0.30 μM, for example, less than 0.25 μM, or less than 0.20 μM, or less than 0.15 μM. In some embodiments, the concentration of bromoform in the composition is at least about 0.05 μM, for example, at least about 0.075 μM, or at least about 0.10 μM. In some embodiments, the concentration is from about 0.05 μM to about 0.20 μM, for example, from about 0.075 μM to about 0.175 μM, or from about 0.10 μM to about 0.15 μM, or from about 0.11 μM to about 0.13 μM.

In some embodiments, the concentration of the at least one other compound in the composition is higher than the concentration of bromoform. For example, in some embodiments, the concentration of the at least one other compound is at least about 2.0 μM, for example, at least about 10.0 μM, or at least about 50.0 μM, or at least about 100.0 μM, or at least about 250.0 μM, or at least about 500.0 μM, or at least about 750.0 μM. In some embodiments, the concentration of the at least one other compound is less than about 5.0 mM, for example, less than about 2.5 mM, or less than about 1.0 mM, or less than about 750.0 μM, or less than about 500.0 M, or less than about 250.0 μM.

In some embodiments, the concentration of the at least one other compound in the composition is from about 0.15 μM to about 1.0 mM, for example, from about 2.0 μM to about 1.0 mM, or from about 2.0 M to about 750.0 μM, or from about 2.0 μM to about 500.0 M, or from about 2.0 μM to about 250.0 μM, or from about 2.0 μM to about 150.0 μM, or from about 2.0 μM to about 100.0 μM.

In some embodiments, the at least one other compound is dibromochloromethane and the concentration of dibromochloromethane in the composition is from about 0.15 μM to about 1.0 μM, for example, from about 0.15 μM to about 0.5 μM, or from about 0.15 μM to about 0.25 μM.

In some embodiments, the at least one other compound is diallyl disulfide and the concentration of diallyl disulfide in the composition is from about 5.0 μM to about 500.0 μM, for example, from about 10.0 μM to about 350.0 μM, or from about 15.0 μM to about 250.0 μM.

In some embodiments, the at least one other compound is diallyl trisulfide and the concentration of diallyl trisulfide in the composition is from about 50.0 μM to about 250.0 μM, for example, from about 75.0 μM to about 200.0 μM, or from about 100.0 μM to about 150.0 μM.

In some embodiments, the at least one other compound is dimethyl disulfide and the concentration of dimethyl disulfide in the composition is from about 500.0 μM to about 1.5 mM, for example, from about 750 μM to about 1.25 mM, or from about 900.0 μM to about 1.1 mM.

In some embodiments, the at least one other compound is dipropyl disulfide and the concentration of dipropyl disulfide in the composition is from about 500.0 μM to about 1.5 mM, for example, from about 750 μM to about 1.25 mM, or from about 900.0 μM to about 1.1 mM.

In some embodiments, the at least one other compound is prenylnaringenin (for example, 6 -prenylnaringenin or 8-prenylnaringenin) and the concentration of prenylnaringenin in the composition is from about 2.0 μM to about 50.0 μM, for example, from about 5.0 μM to about 25.0 μM, or from about 10.0 μM to about 15.0 μM. In an embodiment, the prenylnaringenin is 8-prenylnaringenin.

In some embodiments, the at least one other compound is bavachin and the concentration of bavachin in the composition is from about 5.0 μM to about 75.0 μM, for example, from about 10.0 μM to about 50.0 μM, or from about 15.0 μM to about 35.0 μM, or from about 20.0 μM to about 30.0 μM.

In some embodiments, the at least one other compound is bavachinin and the concentration of bavachinin in the composition is from about 2.0 μM to about 200.0 μM, for example, from about 5.0 μM to about 150.0 μM, or from about 10.0 μM to about 125.0 μM.

In some embodiments, the at least one other compound is corylifol A or corylifol C and the concentration of corylifol A or corylifol C in the composition is from about 0.5 μM to about 10.0 μM, for example, from about 1.0 μM to about 7.5 μM, or from about 2.0 μM to about 5.0 μM. In an embodiment, the at least one other compound is corylifol A.

In some embodiments, the at least one other compound is morusin and the concentration of morusin in the composition is from about 0.25 μM to about 50.0 μM, for example, from about 0.50 μM to about 25.0 μM, or from about 1.0 μM to about 15.0 μM.

In some embodiments, the at least one other compound is isobavachalone and the concentration of isobavachalone in the composition is from about 1.0 μM to about 15.0 μM, for example, from about 2.5 M to about 12.5 μM, or from about 4.0 μM to about 10.0 μM, or from about 5.0 M to about 7.5 μM.

In some embodiments, the at least one other compound is naringenin and the concentration of naringenin in the composition is from about 25.0 μM to about 250.0 μM, for example, from about 50.0 μM to about 150.0 μM, or from about 75.0 μM to about 125.0 μM, or from about 90.0 μM to about 110.0 μM.

In some embodiments, the at least one other compound is quercetin and the concentration of quercetin in the composition is from about 25.0 μM to about 250.0 μM, for example, from about 50.0 μM to about 150.0 μM, or from about 75.0 μM to about 125.0 μM, or from about 90.0 μM to about 110.0 μM.

In some embodiments, the at least one other compound is xanthohumol and the concentration of xanthohumol in the composition is from about 2.0 μM to about 50.0 μM, for example, from about 5.0 μM to about 25.0 μM, or from about 10.0 μM to about 15.0 μM.

In some embodiments, the at least one other compound is tannic acid and the concentration of tannic acid in the composition is from about 25.0 μM to about 250.0 μM, for example, from about 50.0 μM to about 150.0 μM, or from about 75.0 μM to about 125.0 μM, or from about 90.0 μM to about 110.0 μM.

In some embodiments, the at least one other compound is carvacrol and the concentration of carvacrol in the composition is from about 250.0 μM to about 1.0 mM, for example, from about 250 μM to about 750.0 μM, or from about 400.0 M to about 600.0 μM, or from about 450.0 μM to about 550.0 μM.

In some embodiments, the at least one other compound is citral and the concentration of citral in the composition is from about 250.0 μM to about 1.0 mM, for example, from about 250 μM to about 750.0 μM, or from about 400.0 M to about 600.0 μM, or from about 450.0 μM to about 550.0 μM.

In some embodiments, the at least one other compound is cinnamaldehyde and the concentration of cinnamaldehyde in the composition is from about 500.0 μM to about 1.5 mM, for example, from about 750 μM to about 1.25 mM, or from about 900.0 μM to about 1.1 mM.

In some embodiments, the at least one other compound is hexylcinnamaldehyde (for example, α-hexylcinnamaldehyde or 2-hexylcinnamaldehyde) and the concentration of hexylcinnamaldehyde in the composition is from about 10.0 M to about 75.0 μM, for example, from about 15.0 μM to about 50.0 μM, or from about 20.0 μM to about 40.0 μM, or from about 25.0 M to about 35.0 μM. In an embodiment, the at least one other compound is α-hexylcinnamaldehyde.

In some embodiments, the at least one other compound is sclareol and the concentration of sclareol in the composition is from about 5.0 μM to about 75.0 μM, for example, from about 10.0 μM to about 50.0 μM, or from about 15.0 μM to about 35.0 μM, or from about 20.0 μM to about 30.0 μM.

In some embodiments, the at least one other compound is saikosaponin (for example, saikosaponin A, saikosaponin b2, saikosaponin C or saikosaponin D) and the concentration of saikosaponin in the composition is from about 2.0 μM to about 25.0 μM, for example, from about 5.0 μM to about 15.0 μM, or from about 8.0 μM to about 12.0 μM. In an embodiment, the at least one other compound is saikosaponin b2.

In some embodiments, the at least one other compound is ursolic acid and the concentration of ursolic acid in the composition is from about 25.0 μM to about 250.0 μM, for example, from about 50.0 μM to about 150.0 M, or from about 75.0 μM to about 125.0 μM, or from about 90.0 μM to about 110.0 μM.

In some embodiments, the at least one other compound is ginsenoside (for example, ginsenoside Rb1, ginsenoside Rb2, ginsenoside Rc, ginsenoside Rd, ginsenoside Re, ginsenoside Rg1 or ginsenoside Rf) and the concentration of ginsenoside in the composition is from about 5.0 μM to about 50.0 μM, for example, from about 10.0 μM to about 40.0 μM, or from about 15.0 μM to about 30.0 μM, or from about 15.0 μM to about 25.0 μM. In an embodiment, the at least one other compound is ginsenoside Rb2.

In some embodiments, the at least one other compound is dibromoacetic acid and the concentration of dibromoacetic acid in the composition is from about 50.0 μM to about 500.0 μM, for example, from about 100.0 μM to about 350.0 μM, or from about 150.0 μM to about 250.0 μM, or from about 175.0 μM to about 225.0 μM.

In some embodiments, the at least one other compound is 3-nitrooxypropanol and the concentration of 3-nitrooxypropanol in the composition is from about 0.25 μM to about 4.0 μM, for example, from about 0.50 μM to about 2.5 μM, or from about 0.50 μM to about 1.75 μM, or from about 0.50 μM to about 1.5 μM, or from about 0.50 μM to about 1.0 μM, or from about 0.70 μM to about 0.85 μM.

In some embodiments, the at least one other compound is cinnamon bark oil and the amount of cinnamon bark oil in the composition is from about 100 ppm to about 500 ppm, for example, from about 150 ppm to about 350 ppm, or from about 200 ppm to about 300 ppm, or from about 225 ppm to about 275 ppm.

In some embodiments, the at least one other compound is garlic oil and the amount of garlic oil in the composition is from about 10 ppm to about 250 ppm, for example, from about 25 ppm to about 150 ppm, or from about 40 ppm to about 100 ppm, or from about 50 ppm to about 75 ppm.

In some embodiments, the at least one other compound is sandalwood oil and the amount of sandalwood oil in the composition is from about 1 ppm to about 20 ppm, for example, from about 3 ppm to about 15 ppm, or from about 4 ppm to about 10 ppm, or from about 6 ppm to about 8 ppm, or from about 7 ppm to about 8 ppm.

In some embodiments, the at least one other compound is thyme red oil and the amount of thyme red oil in the composition is from about 10 ppm to about 250 ppm, for example, from about 50 ppm to about 200 ppm, or from about 75 ppm to about 150 ppm, or from about 100 ppm to about 150 ppm.

In some embodiments, the at least one other compound is lemongrass oil and the amount of lemongrass oil in the composition is from about 10 ppm to about 250 ppm, for example, from about 50 ppm to about 200 ppm, or from about 75 ppm to about 150 ppm, or from about 100 ppm to about 150 ppm.

In some embodiments, the at least one other compound is lemon verbena oil and the amount of lemon verbena oil in the composition is from about 10 ppm to about 250 ppm, for example, from about 50 ppm to about 200 ppm, or from about 75 ppm to about 150 ppm, or from about 100 ppm to about 150 ppm.

### Ratio of Iodoform to the at Least One Other Compound(s)

In some embodiments, the composition comprises iodoform and at least one other compound, for example iodoform and one other compound.

In some embodiments, the ratio of the concentration of iodoform to the at least one other compound is from about 1:0.05 to about 1:10,000. For example, in some embodiments, the ratio of iodoform to the at least one other compound is from about 1:0.05 to about 1:100, or from about 1:0.1 to about 1:75, or from about 1:0.1 to about 1:50.

In some embodiments, the at least one other compound is dibromomethane and the ratio of the concentration of iodoform to dibromomethane is from about 1:0.05 to about 1:1, or about 1:0.1 to about 1:0.75, or from about 1:0.15 to about 1:0.5, or from about 1:0.2 to about 1:0.3.

In some embodiments, the at least one other compound is selected from diallyl disulfide, diallyl trisulfide, dimethyl disulfide and dipropyl disulfide and the ratio of the concentration of iodoform to said compound is from about 1:1 to about 1:100, or from about 1:5 to about 1:50, or from about 1:10 to about 1:25, or from about 1:10 to about 1:20.

In some embodiments, the at least one other compound is diallyl disulfide and the ratio of iodoform to said diallyl disulfide is from about 1:1 to about 1:100, or from about 1:5 to about 1:50, or from about 1:10 to about 1:25, or from about 1:10 to about 1:20, or from about 1:10 to about 1:15.

In some embodiments, the at least one other compound is diallyl trisulfide and the ratio of the concentration of iodoform to said diallyl trisulfide is from about 1:1 to about 1:100, or from about 1:5 to about 1:50, or from about 1:10 to about 1:25, or from about 1:10 to about 1:20, or from about 1:10 to about 1:15.

In some embodiments, the at least one other compound is dipropyl disulfide and the ratio of the concentration of iodoform to dipropyl disulfide is from about 1:1 to about 1:100, or from about 1:5 to about 1:50, or from about 1:10 to about 1:25, or from about 1:12.5 to about 1:20, or from about 1:12.5 to about 1:17.5.

In some embodiments, the at least one other compound is selected from prenylnaringenin (for example, 6-prenylnaringenin or 8-prenylnaringenin), bavachin, bavachinin, corylifol (for example, corylifol A or corylifol C), morusin, isobavachalcone, naringenin, quercetin and xanthohumol and the ratio of the concentration of iodoform to said compound is from about 1:1 to about 1:500, or from about 1:5 to about 1:250, or from about 1:10 to about 1:100, or from about 1:25 to about 1:75.

In some embodiments, the at least one other compound is naringenin and the ratio of the concentration of iodoform to said compound is from about 1:1 to about 1:500, or from about 1:5 to about 1:250, or from about 1:10 to about 1:100, or from about 1:25 to about 1:75, or from about 1:40 to about 1:60.

In some embodiments, the at least one other compound is selected from cinnamon bark oil, garlic oil, sandalwood oil, thyme red oil, lemongrass oil and lemon verbena oil and the ratio of the concentration of iodoform to the amount of said compound is from about 1:0.5 to about 1:100, or from about 1:1 to about 1:75, or from about 1:2.5 to about 1:50 or from about 1:5 to about 1:30.

In some embodiments, the at least one other compound is garlic oil and the ratio of the concentration of iodoform to the amount of said compound is from about 1:0.5 to about 1:100, from about 1:1 to about 1:50, or from about 1:2.5 to about 1:25 or from about 1:5 to about 1:10.

In some embodiments, the at least one other compound is thyme red oil and the ratio of the concentration of iodoform to the amount of said compound is from about 1:1 to about 1:100, from about 1:2.5 to about 1:75, or from about 1:5 to about 1:50 or from about 1:10 to about 1:40, is from about 1:20 to about 1:30.

In some embodiments, the at least one other compound is lemongrass oil and the ratio of the concentration of iodoform to the amount of said compound is from about 1:1 to about 1:100, from about 1:2.5 to about 1:75, or from about 1:5 to about 1:50 or from about 1:10 to about 1:40, is from about 1:20 to about 1:30.

In some embodiments, the at least one other compound is selected from carvacrol, citral, cinnamaldehyde and hexylcinnamaldehyde (for example, α-hexylcinnamaldehyde or 2-hexylcinnamaldehyde) and the ratio of the concentration of iodoform to said compound is from about 1:1 to about 1:100, or from about 1:5 to about 1:50, or from about 1:10 to about 1:25, or from about 1:10 to about 1:20, or from about 1:10 to about 1:15.

In some embodiments, the at least one other compound is hexylcinnamaldehyde (for example, α-hexylcinnamaldehyde or 2-hexylcinnamaldehyde) and the ratio of the concentration of iodoform to said compound is from about 1:1 to about 1:100, or from about 1:5 to about 1:50, or from about 1:10 to about 1:25, or from about 1:10 to about 1:20, or from about 1:10 to about 1:15. In an embodiment, the at least one other compound is α-hexylcinnamaldehyde.

In some embodiments, the at least one other compound is pyromellitic diimide and the ratio of concentration of the iodoform to pyromellitic diimide is from about 1:0.05 to about 1:25, or from about 1:0.1 to about 1:10, or from about 1:0.5 to about 1:5, or from about 1:1 to about 1:2.5.

In some embodiments the composition comprises iodoform and at least two other compounds, for example iodoform and two other compounds. In some embodiments, the composition comprises iodoform and at least two other compounds selected from a group consisting of dibromomethane, pyromellitic diimide, naringenin, dipropyl disulfide, garlic oil, diallyl disulfide, diallyl trisulfide, hexylcinnamaldehyde (for example, α-hexylcinnamaldehyde), thyme red oil, lemongrass oil, and any combination thereof. In some embodiments, the composition comprises iodoform, dibromomethane and one other compound selected from a group consisting of naringenin, dipropyl disulfide, garlic oil, diallyl disulfide, or diallyl trisulfide.

In some embodiments, the ratio of the concentration of iodoform to the at least two other compounds is from about 1:0.05:1 to about 1:1:500. For example, in some embodiments, the ratio of iodoform to the at least two other compounds is from about 1:0.05:1 to about 1:0.75:250, or from about 1:0.15:2 to about 1:0.5:100, or from about 1:0.2:5 to about 1:0.3:50.

In some embodiments, one of the at least two other compounds is dibromomethane and the ratio of the concentration of iodoform to dibromomethane is from about 1:0.05 to about 1:1, or about 1:0.1 to about 1:0.75, or from about 1:0.15 to about 1:0.5, or from about 1:0.2 to about 1:0.3.

In some embodiments, one of the at least two other compounds is selected from diallyl disulfide, diallyl trisulfide, dimethyl disulfide and dipropyl disulfide and the ratio of the concentration of iodoform to said compound is from about 1:1 to about 1:100, or from about 1:5 to about 1:50, or from about 1:10 to about 1:25, or from about 1:10 to about 1:20.

In some embodiments, one of the at least two other compounds is diallyl disulfide and the ratio of iodoform to said diallyl disulfide is from about 1:1 to about 1:100, or from about 1:5 to about 1:50, or from about 1:10 to about 1:25, or from about 1:10 to about 1:20, or from about 1:10 to about 1:15.

In some embodiments, one of the at least two other compounds is diallyl trisulfide and the ratio of the concentration of iodoform to said diallyl trisulfide is from about 1:1 to about 1:100, or from about 1:5 to about 1:50, or from about 1:10 to about 1:25, or from about 1:10 to about 1:20, or from about 1:10 to about 1:15.

In some embodiments, one of the at least two other compounds is dipropyl disulfide and the ratio of the concentration of iodoform to dipropyl disulfide is from about 1:1 to about 1:100, or from about 1:5 to about 1:50, or from about 1:10 to about 1:25, or from about 1:12.5 to about 1:20, or from about 1:12.5 to about 1:17.5.

In some embodiments, one of the at least two other compounds is selected from prenylnaringenin (for example, 6-prenylnaringenin or 8-prenylnaringenin), bavachin, bavachinin, corylifol (for example, corylifol A or corylifol C), morusin, isobavachalcone, naringenin, quercetin and xanthohumol and the ratio of the concentration of iodoform to said compound is from about 1:1 to about 1:500, or from about 1:5 to about 1:250, or from about 1:10 to about 1:100, or from about 1:25 to about 1:75.

In some embodiments, one of the at least two other compounds is naringenin and the ratio of the concentration of iodoform to said compound is from about 1:1 to about 1:500, or from about 1:5 to about 1:250, or from about 1:10 to about 1:100, or from about 1:25 to about 1:75, or from about 1:40 to about 1:60.

In some embodiments, one of the at least two other compounds is selected from cinnamon bark oil, garlic oil, sandalwood oil, thyme red oil, lemongrass oil and lemon verbena oil and the ratio of the concentration of iodoform to the amount of said compound is from about 1:0.5 to about 1:100, or from about 1:1 to about 1:75, or from about 1:2.5 to about 1:50 or from about 1:5 to about 1:30.

In some embodiments, one of the at least two other compounds is garlic oil and the ratio of the concentration of iodoform to the amount of said compound is from about 1:0.5 to about 1:100, from about 1:1 to about 1:50, or from about 1:2.5 to about 1:25 or from about 1:5 to about 1:10.

In some embodiments, one of the at least two other compounds is thyme red oil and the ratio of the concentration of iodoform to the amount of said compound is from about 1:1 to about 1:100, from about 1:2.5 to about 1:75, or from about 1:5 to about 1:50 or from about 1:10 to about 1:40, is from about 1:20 to about 1:30.

In some embodiments, one of the at least two other compounds is lemongrass oil and the ratio of the concentration of iodoform to the amount of said compound is from about 1:1 to about 1:100, from about 1:2.5 to about 1:75, or from about 1:5 to about 1:50 or from about 1:10 to about 1:40, is from about 1:20 to about 1:30.

In some embodiments, one of the at least two other compounds is selected from carvacrol, citral, cinnamaldehyde and hexylcinnamaldehyde (for example, α-hexylcinnamaldehyde or 2-hexylcinnamaldehyde) and the ratio of the concentration of iodoform to said compound is from about 1:1 to about 1:100, or from about 1:5 to about 1:50, or from about 1:10 to about 1:25, or from about 1:10 to about 1:20, or from about 1:10 to about 1:15.

In some embodiments, one of the at least two other compounds is hexylcinnamaldehyde (for example, α-hexylcinnamaldehyde or 2-hexylcinnamaldehyde) and the ratio of the concentration of iodoform to said compound is from about 1:1 to about 1:100, or from about 1:5 to about 1:50, or from about 1:10 to about 1:25, or from about 1:10 to about 1:20, or from about 1:10 to about 1:15. In an embodiment, the at least one other compound is α-hexylcinnamaldehyde.

In some embodiments, one of the at least two other compounds is pyromellitic diimide and the ratio of concentration of the iodoform to pyromellitic diimide is from about 1:0.05 to about 1:25, or from about 1:0.1 to about 1:10, or from about 1:0.5 to about 1:5, or from about 1:1 to about 1:2.5

In some embodiments, the at least two other compounds are dibromomethane and diallyl disulfide and the concentration of iodoform to dibromomethane to diallyl disulfide is from about 1:0.05:1 to about 1:1:50, or about 1:0.1:5 to about 1:0.75:25, or from about 1:0.15:10 to about 1:0.5:20, or from about 1:0.2:10 to about 1:0.3:15.

In some embodiments, the at least two other compounds are dibromomethane and diallyl trisulfide and the concentration of iodoform to dibromomethane to diallyl trisulfide is from about 1:0.05:1 to about 1:1:50, or about 1:0.1:5 to about 1:0.75:25, or from about 1:0.15:10 to about 1:0.5:20, or from about 1:0.2:10 to about 1:0.3:15.

In some embodiments, the at least two other compounds are dibromomethane and dipropyl disulfide and the concentration of iodoform to dibromomethane to dipropyl disulfide is from about 1:0.05:1 to about 1:1:50, or about 1:0.1:5 to about 1:0.75:25, or from about 1:0.15:10 to about 1:0.5:20, or from about 1:0.2:12.5 to about 1:0.3:17.5

In some embodiments, the at least two other compounds are dibromomethane and naringenin and the concentration of iodoform to dibromomethane to naringenin is from about 1:0.05:5 to about 1:1:250, or about 1:0.1:10 to about 1:0.75:100, or from about 1:0.15:25 to about 1:0.5:75, or from about 1:0.2:40 to about 1:0.3:60.

In some embodiments, the at least two other compounds are dibromomethane and garlic oil and the concentration of iodoform to dibromomethane to garlic oil is from about 1:0.05:0.5 to about 1:1:100, or about 1:0.1:1 to about 1:0.75:50, or from about 1:0.15:2.5 to about 1:0.5:25, or from about 1:0.2:5 to about 1:0.3:10.

Iodoform is generally more stable at relatively high concentrations and less toxic at these concentrations than bromoform.

In some embodiments, the concentration of iodoform in the composition is at least about 0.5 μM, for example, at least about 1 M, or at least about 2 μM, or at least about 5 μM, or at least about 10 μM. In some embodiments, the concentration is from about 0.5 μM to about 50 μM, or from about 1 μM to about 25 μM, or from about 1.5 μM to about 12.5 μM. In some embodiments iodoform is from about 1 μM to about 5 μM, for example 1.5 μM to about 2.5 μM.

In some embodiments, the concentration of the at least one other compound is at least about 0.5 μM, at least about 2.0 M, for example, at least about 10 μM, or at least about 50 μM, or at least about 100.0 μM, or at least about 250 μM, or at least about 500 μM, or at least about 750 μM. In some embodiments, the concentration of the at least one other compound is less than about 5.0 mM, for example, less than about 2.5 mM, or less than about 1.0 mM, or less than about 750 μM, or less than about 500 μM, or less than about 250 μM, or less than about 100 μM, or less than about 50 μM, or less than about 10 μM, or less than about 5 μM.

In some embodiments, the concentration of the at least one other compound in the composition is from about 0.15 μM to about 1.0 mM, for example, from about 0.5 μM to about 1.0 mM, or from about 2.0 μM to about 750 μM, or from about 2.0 μM to about 500 μM, or from about 2.0 μM to about 250 μM, or from about 2.0 μM to about 150 μM, or from about 2.0 μM to about 100 μM.

In some embodiments, the at least one other compound is dibromomethane and the concentration of dibromomethane in the composition is from about 0.05 μM to about 50 μM, or from about 0.1 μM to about 25 μM, or from about 0.25 μM to about 12.5 μM.

In some embodiments, the at least one other compound is diallyl disulfide and the concentration of diallyl disulfide in the composition is from about 0.1 μM to about 100 μM, or from about 0.5 μM to about 75 μM, or from about 1.0 μM to about 50 μM, or from about 5.0 μM to about 40 μM, or from about 15 μM to about 30 μM.

In some embodiments, the at least one other compound is diallyl trisulfide and the concentration of diallyl trisulfide in the composition is from about 0.1 μM to about 100 μM, or from about 0.5 μM to about 75 μM, or from about 1.0 μM to about 50 μM, or from about 5.0 μM to about 40 μM, or from about 15 μM to about 30 μM.

In some embodiments, the at least one other compound is dipropyl disulfide and the concentration of dipropyl disulfide in the composition is from about 0.5 μM to about 100 μM, or from about 1.0 μM to about 80 M, or from about 5.0 μM to about 60 μM, or from about 10 μM to about 50 μM, or from about 15 μM to about 40 μM, or from about 20 μM to about 40 μM.

In some embodiments, the at least one other compound is naringenin and the concentration of naringenin in the composition is from about 25 μM to about 250 μM, for example, from about 50 μM to about 150 M, or from about 75 μM to about 125 M, or from about 90 μM to about 110 μM.

In some embodiments, the at least one other compound is hexylcinnamaldehyde (for example, α-hexylcinnamaldehyde or 2-hexylcinnamaldehyde) and the concentration of hexylcinnamaldehyde in the composition is from about 10 μM to about 75 μM, for example, from about 15 μM to about 50 μM, or from about 20 μM to about 40 μM, or from about 25 μM to about 35 μM. In an embodiment, the at least one other compound is α-hexylcinnamaldehyde.

In some embodiments, the at least one other compound is garlic oil and the amount of garlic oil in the composition is from about 0.5 ppm, or is from about 1 ppm, or is from about 2 ppm, or is from about 3 ppm, or is from about 4 ppm, or is from about 5 ppm.

In some embodiments, the at least one other compound is thyme red oil and the amount of thyme red oil in the composition is from about 0.5 ppm to about 50 ppm, or is from about 1 ppm to about 40 ppm, or is from about 5 ppm to about 35 ppm, or is from about 10 ppm to about 30 ppm, or is from about 15 ppm to about 25 ppm.

In some embodiments, the at least one other compound is lemongrass oil and the amount of lemongrass oil in the composition is from about 0.5 ppm to about 50 ppm, or is from about 1 ppm to about 40 ppm, or is from about 5 ppm to about 35 ppm, or is from about 10 ppm to about 30 ppm, or is from about 15 ppm to about 25 ppm.

In some embodiments, the at least one other compound is pyromellitic diimide and the amount of pyromellitic diimide in the composition is from about 0.1 ppm to about 10 ppm, or from about 0.25 ppm to about 7.5 ppm, or from about 0.5 to about 5 ppm, or from about 0.75 ppm to about 2.5 ppm.

In some embodiments, one of the at least two other compounds is dibromomethane and the concentration of dibromomethane in the composition is from about 0.05 μM to about 50 M, or from about 0.1 μM to about 25 μM, or from about 0.25 μM to about 12.5 μM. In some embodiments the concentration of dibromomethane is from about 0.1 μM to about 1 μM, for example from about 0.25 μM to about 0.75 μM.

In some embodiments, one of the at least two other compounds is diallyl disulfide and the concentration of diallyl disulfide in the composition is from about 0.1 μM to about 100 μM, or from about 0.5 μM to about 75 μM, or from about 1.0 μM to about 50 μM, or from about 5.0 μM to about 40 μM, or from about 15 μM to about 30 μM.

In some embodiments, one of the at least two other compounds is diallyl trisulfide and the concentration of diallyl trisulfide in the composition is from about 0.1 μM to about 100 μM, or from about 0.5 M to about 75 M, or from about 1.0 μM to about 50 M, or from about 5.0 μM to about 40 μM, or from about 15 μM to about 30 μM.

In some embodiments, one of the at least two other compounds is dipropyl disulfide and the concentration of dipropyl disulfide in the composition is from about 0.5 μM to about 100 μM, or from about 1.0 μM to about 80 μM, or from about 5.0 μM to about 60 μM, or from about 10 μM to about 50 μM, or from about 15 μM to about 40 μM, or from about 20 μM to about 40 μM.

In some embodiments, one of the at least two other compounds is naringenin and the concentration of naringenin in the composition is from about 25 μM to about 250 μM, for example, from about 50 μM to about 150 μM, or from about 75 μM to about 125 M, or from about 90 μM to about 110 μM.

In some embodiments, one of the at least two other compounds is hexylcinnamaldehyde (for example, α-hexylcinnamaldehyde or 2-hexylcinnamaldehyde) and the concentration of hexylcinnamaldehyde in the composition is from about 10 μM to about 75 μM, for example, from about 15 μM to about 50 μM, or from about 20 μM to about 40 μM, or from about 25 μM to about 35 M. In an embodiment, the at least one other compound is α-hexylcinnamaldehyde.

In some embodiments, one of the at least two other compounds is garlic oil and the amount of garlic oil in the composition is from about 0.5 ppm, or is from about 1 ppm, or is from about 2 ppm, or is from about 3 ppm, or is from about 4 ppm, or is from about 5 ppm.

In some embodiments, one of the at least two other compounds is thyme red oil and the amount of thyme red oil in the composition is from about 0.5 ppm to about 50 ppm, or is from about 1 ppm to about 40 ppm, or is from about 5 ppm to about 35 ppm, or is from about 10 ppm to about 30 ppm, or is from about 15 ppm to about 25 ppm.

In some embodiments, one of the at least two other compounds is lemongrass oil and the amount of lemongrass oil in the composition is from about 0.5 ppm to about 50 ppm, or is from about 1 ppm to about 40 ppm, or is from about 5 ppm to about 35 ppm, or is from about 10 ppm to about 30 ppm, or is from about 15 ppm to about 25 ppm.

In some embodiments, one of the at least two other compounds is pyromellitic diimide and the amount of pyromellitic diimide in the composition is from about 0.1 ppm to about 10 ppm, or from about 0.25 ppm to about 7.5 ppm, or from about 0.5 to about 5 ppm, or from about 0.75 ppm to about 2.5 ppm.

In some embodiments, the at least two other compounds are dibromomethane and diallyl disulfide, and the concentration of iodoform in the composition is from about 0.5 μM to about 10 μM, or from about 1 μM to about 5 μM, or from about 1.5 μM to about 2.5 μM; the concentration of dibromomethane is from about 0.1 μM to about 1 μM, for example from about 0.25 μM to about 0.75 μM; and the concentration of diallyl disulfide is from about 1.0 μM to about 50 μM, or from about 5.0 μM to about 40 μM, or from about 15 μM to about 30 μM, or from about 20 μM to about 30 M.

In some embodiments, the at least two other compounds are dibromomethane and diallyl trisulfide, and the concentration of iodoform in the composition is from about 0.5 μM to about 10 μM, or from about 1 μM to about 5 μM, or from about 1.5 μM to about 2.5 μM; the concentration of dibromomethane is from about 0.1 μM to about 1 μM, for example from about 0.25 μM to about 0.75 μM; and the concentration of diallyl trisulfide is from about 1.0 μM to about 50 μM, or from about 5.0 μM to about 40 μM, or from about 15 μM to about 30 μM, or from about 20 μM to about 30 μM.

In some embodiments, the at least two other compounds are dibromomethane and dipropyl disulfide, and the concentration of iodoform in the composition is from about 0.5 μM to about 10 μM, or from about 1 μM to about 5 μM, or from about 1.5 μM to about 2.5 M; the concentration of dibromomethane is from about 0.1 μM to about 1 μM, for example from about 0.25 μM to about 0.75 μM; and the concentration of dipropyl disulfide is from about 10 μM to about 50 μM, or from about 15 μM to about 40 μM, or from about 20 μM to about 40 μM

In some embodiments, the at least two other compounds are dibromomethane and naringenin, and the concentration of iodoform in the composition is from about 0.5 μM to about 10 μM, or from about 1 μM to about 5 μM, or from about 1.5 μM to about 2.5 μM; the concentration of dibromomethane is from about 0.1 μM to about 1 μM, for example from about 0.25 μM to about 0.75 M; and the concentration of naringenin is from about 50 μM to about 150 μM, or from about 75 μM to about 125 μM, or from about 90 M to about 110 μM.

In some embodiments, the at least two other compounds are dibromomethane and garlic oil, and the concentration of iodoform in the composition is from about 0.5 μM to about 10 μM, or from about 1 μM to about 5 μM, or from about 1.5 μM to about 2.5 μM; the concentration of dibromomethane is from about 0.1 μM to about 1 μM, for example from about 0.25 μM to about 0.75 μM; and the amount of garlic oil is from about 1 ppm, or is from about 2 ppm, or is from about 3 ppm, or is from about 4 ppm, or is from about 5 ppm.

### Animal Feed Composition

The composition disclosed herein (including all embodiment and any combination of embodiments) may be provided in the form of an animal feed composition or combined with animal feed to form an animal feed composition.

The animal feed may, for example, be any composition suitable for providing nutrition to an animal, particularly a ruminant animal. For example, the animal feed may be suitable for any ruminant animal, for example cows, goats, sheep, yaks, deer or antelope. The animal feed may be suitable for any pseudo-ruminant animal, for example, camels and hippopotami. The animal feed may be suitable for any monogastric animal, for example kangaroos, rats, dogs, pigs, cats, horses, birds (such as pigeons, penguins) and rabbits. The animal feed may be suitable for monogastric herbivores such as kangaroos, horses and rabbits.

The animal feed may be solid (e.g., powder, granules, pellets), semi-solid (e.g., gel, cream, paste) or liquid (e.g., solutions, suspensions, emulsions). The composition of the invention may, for example, be used to “top-dress” (added on top) an animal feedlot ration or may be used to blend into a total mixed ration. The animal feed may, for example, be added to the drinking water of the animal. In certain embodiments, the composition of the invention may be added to the drinking water of the animal immediately before ingestion, for example up to 1 hour before ingestion or up to 30 minutes before ingestion or up to 15 minutes before ingestion or up to 5 minutes before ingestion.

The three main types of animal feed include roughages, concentrates and mixed feeds. In general, roughages contain a high percentage of crude fibre and a low percentage of digestible nutrients. For example, roughages may be defined as containing equal to or greater than 20 wt. % crude fibre and equal to or less than 80 wt. % total digestible nutrients, for example, equal to or greater than 20 wt. % crude fibre and equal to or less than 70 wt. % total digestible nutrients, equal to or greater than 20 wt. % crude fibre and equal to or less than 60 wt. % total digestible nutrients. Roughages may include, for example, dry roughages (e.g., hay, straw, artificially dehydrated forages containing at least 90 wt. % dry matter), silages (formed from green forages such as grass, alfalfa, sorghum and corn and preserved in a silo at dry matter contents of 20 to 50%), and pastures (e.g., green growing pastures providing forage that has a high water content and only 20 to 30% dry matter). The two basic types of roughages include grasses and legumes. Grasses are generally higher in fibre and dry matter than legumes. Legumes are generally higher in proteins, energy, vitamins and minerals.

Concentrates are the opposite of roughages and contain a low percentage of crude fibre and a high percentage of digestible nutrients. For example, concentrates may be defined as containing less than 20 wt. % crude fibre and greater than 60 wt. % total digestible nutrients. Concentrates may include, for example, energy-rich grains and molasses. Corn, oats, barley and milo (sorghum grain) are energy-rich grains, containing about 70 to 80 wt. % total digestible nutrients. Concentrates also include, for example, wheat bran, rice bran, wheat middlings, rye middlings and rice polish.

Mixed feeds are generally a mixture of roughages and concentrates to provide “complete” balanced rations and may be either high or low in energy, protein or fibre.

The composition of the invention may be provided in concentrate form for addition to an animal feed composition.

The trihalomethane other than dibromochloromethane, for example bromoform or iodoform, and the at least one other compound as described herein may, for example, be combined with animal feed in various amounts depending on the total amount of trihalomethane other than dibromochloromethane, for example, bromoform or iodoform, and at least one other compound that are intended to be administered to or consumed by the animal.

The animal feed composition may, for example, comprise from about 0.0001 wt. % to about 10 wt. % of the composition of the invention, for example, from about 0.01 wt. % to about 10 wt. %, based on the total dry weight of the animal feed composition. For example, the animal feed composition may comprise from about 0.1 wt. % to about 9.5 wt. % or from about 0.4 wt. % to about 9.5 wt. % or from about 0.5 wt. % to about 9 wt. % or from about 0.6 wt. % to about 8.5 wt. % or from about 0.7 wt. % to about 8 wt. % or from about 0.8 wt. % to about 7.5 wt. % or from about 0.9 wt. % to about 7 wt. % or from about 1 wt. % to about 6 wt. % or from about 1.5 wt. % to about 5.5 wt. % or from about 2 wt. % to about 5 wt. % or from about 2.5 wt. % to about 4.5 wt. % or from about 3 wt. % to about 4 wt. % of the composition of the invention, based on the total dry weight of the animal feed composition. For example, the animal feed composition may comprise from about 0.0001 wt. % to about 1.0 wt. % or from about 0.001 wt. % to about 0.8 wt. % or from about 0.01 wt. % to about 0.5 wt. % or from about 0.1 wt. % to about 0.4 wt. % of the composition of the invention, based on the total dry weight of the animal feed composition.

The animal feed composition may, for example, further comprise other animal feed supplements including, for example, vitamins, minerals, antibiotics, growth stimulants and combinations thereof. For example, the animal feed composition may comprise other biologically active animal feed supplements, for example suitable for reducing methane production/emissions and/or increasing availability of nutrients to the animal. The vitamin may be any one or more of vitamin A, vitamin D, vitamin E, vitamin K, thiamine, riboflavin, pyridoxine, cyanocobalamin, carotenoids (including beta-carotene, zeaxanthin, lutein and lycopene), niacin, folic acid, pantothenic acid, biotin, vitamin C, choline, inositol, and salts and derivatives thereof. The mineral may be any one or more of calcium, phosphorous, magnesium, iron, zinc, manganese, copper, cobalt, boron, iodine, sodium, potassium, molybdenum, selenium, chromium, fluorine and chloride. The animal feed composition may, for example, comprise from about 0.001 wt. % to about 5 wt. % of each additional animal feed supplement or from about 0.01 wt. % to about 5 wt. % or from about 0.1 wt. % to about 5 wt. % of each additional animal feed supplement.

The animal feed composition may, for example, comprise other components in addition to the active materials such as, for example, flavourings, colourants, stabilizers (such as rosemary), enhancers (for example digestibility enhancers), buffers, emulsifiers, dispersants, thickeners, solubilising agents, micronutrients (for example selenium), antioxidants (for example vitamins such as Vitamin C, Vitamin E), feed materials (for example carbohydrates, amino acids, and urea) and the like.

The animal feed composition may be in the form of or provided as an animal feed supplement, animal feed additive or complementary feed.

An animal feed supplement refers generally to any substance, preparation or product which is suitable for supplementing an animal feed.

An animal feed additive is a substance, preparation or product which is intentionally added to feed (or water) to perform, in particular, one or more specific functions. For example, in meeting the animal's nutritional requirements, or to improve the quality of feed or to improve the animal's performance and health. Animal feed additives are typically regulated products, i.e., can be placed on the market only if they have been authorized for use and used only for the purpose stated within the authorization.

A complementary feed is a substance, preparation or product which is typically designed to be only a part of the diet of an animal and may not meet the known nutritional requirements when fed alone. They are typically used in combination with additional food types, as described herein, to fulfil daily requirements.

### Methods and Uses

The compositions and animal feed compositions described herein (including all embodiments and combinations of embodiments) may be used to reduce methane production and/or emission by animals, increase availability of nutrients to animals, and/or increase and/or increase efficiency of milk yield and/or body weight gain of animals. Without wishing to be bound by theory, it is believed that the compositions may reduce methane production by microbes in the gut of the animals, thus reducing the nutrients used by those microbes and increasing the availability of the nutrients to the animal. The compositions may improve feed digestion to increase availability of nutrients to an animal.

In certain embodiments, the animal is a ruminant animal. Ruminant animals include, for example, cows, goats, sheep, yaks, deer or antelope. In certain embodiments, the animal is a pseudo-ruminant animal. Pseudo-ruminant animals include, for example, camels and hippopotami. In certain embodiments, the animal is a monogastric animal. Monogastric animals include, for example, kangaroos, rats, dogs, pigs, cats, horses, birds (such as pigeons and penguins) and rabbits. In certain embodiments, the animal is a monogastric herbivore. Monogastric herbivores include, for example, kangaroos, horses and rabbits.

The compositions and animal feed compositions described herein may be administered orally to the animal. The compositions and animal feed compositions described herein may, for example, be administered daily to the animal.

The amount of the animal feed composition administered to or consumed by the animal may vary depending on the requirements of the animal and severity of methane production by the animal. The total daily amount of the animal feed composition administered to or consumed by the animal may, for example, be from about 1 g to about 1000 g per day or from about 10 g to 100 g per day or from about 10 g to about 1000 g per day or from about 100 g to about 1000 g per day or from about 200 g to about 1000 g per day or from about 300 g to about 700 g per day or from about 400 to about 500 g per day. This amount may vary depending on the requirements of the animal and severity of methane production by the animal. For example, the amount of the animal feed composition administered to or consumed by the animal may vary depending on the type of animal, size of animal, age of animal and/or gut microbiome of the subject. Determination of the proper amount for a particular subject is within the skill of the art. The total daily amount may be divided and administered in portions during the day if desired (e.g., two portions or three portions per day). In general, a suitable daily dose of active agents will be that amount which is the lowest dose effective to produce the desired effect. Increasing the amount of the active agents (bromoform and the at least one other compound described herein) administered to/consumed by the animal may, for example, decrease the amount of methane production.

The composition or animal feed composition described herein may, for example, reduce methane production and/or emissions by at least about 1% (compared to methane production and/or emission if the composition or animal feed composition was not consumed), for example, by at least 5% or at least 10%. For example, the composition or animal feed composition may reduce methane production and/or emissions by at least about 15% or at least about 20% or at least about 25% or at least about 30% or at least about 35% or at least about 40% or at least about 45% or at least about 50%. The composition or animal feed composition described herein may, for example, reduce methane production and/or emissions by up to 100%. For example, the composition or animal feed composition may reduce methane production and/or emissions by up to about 99% or up to about 98% or up to about 97% or up to about 96% or up to about 95% or up to about 90% or up to about 85% or up to about 80% or up to about 75% or up to about 70%. This may, for example, be assessed in accordance with the methods described in the examples below.

The animal feed composition described herein may, for example, increase milk yield and/or body weight gain by at least about 1% (compared to milk yield and/or body weight gain if the composition or animal feed composition was not consumed). For example, the composition or animal feed composition may increase milk yield and/or body weight gain by at least about 5% or at least about 10% or at least about 15% or at least about 20% or at least about 25% or at least about 30% or at least about 35% or at least about 40% or at least about 45% or at least about 50%. The composition or animal feed composition described herein may, for example, increase milk yield and/or body weight gain by up to 100%. For example, the composition or animal feed composition may increase milk yield and/or body weight gain by up to about 95% or up to about 90% or up to about 85% or up to about 80% or up to about 75% or up to about 70%. This may be measured, for example, by volume of milk produced per day or by weight of animal. Other measurement techniques include computer tomography (CT) scans to measure empty body mass (total mass less the gut contents), carcass mass, and composition analysis (lean muscle, fat, and major fat distributions; and changes in organs, including the liver).

The composition or animal feed composition described herein may, for example, increase efficiency of milk yield and/or body weight gain of an animal by at least about 1% (compared to efficiency of milk yield and/or body weight gain of an animal if the composition or animal feed composition was not consumed). For example, the composition or animal feed composition may increase efficiency of milk yield and/or body weight gain of an animal by at least about 5% or at least about 10% or at least about 15% or at least about 20% or at least about 25% or at least about 30% or at least about 35% or at least about 40% or at least about 45% or at least about 50%. The composition or animal feed composition described herein may, for example, increase efficiency of milk yield and/or body weight gain of an animal by up to 100%. For example, the composition or animal feed composition may increase efficiency of milk yield and/or body weight gain of an animal by up to about 95% or up to about 90% or up to about 85% or up to about 80% or up to about 75% or up to about 70%. Efficiency relates to the degree to which a particular biological process (e.g., milk, body weight gain) takes place per unit of nutrition consumed. This may be measured, for example, by change in volume of milk produced per day or weight of animal divided by the total nutrients consumed by the animal.

As described herein, the components of the composition or animal feed composition may act synergistically to reduce methane production, inhibit methanogenesis and/or increase milk yield and/or body weight gain of an animal. The synergistic combination of trihalomethane other than dibromochloromethane, for example bromoform or iodoform, and the at least one other compound as described herein delivers an effect that is greater than the sum of the effect by the individual components on their own and thus can provide an improved performance.

In some embodiments, the one or methanogens have the genus Methanobacterium, Methanosarcina, Methanobrevibacter, Methanosarcina, Methanoculleus, Methanosphaera, Methanocorpusculum, Methanofollis, Methanogenium, Methanomicrobium, Methanopyrus, Methanoregula, Methanasaeta, Methanthermobacter or Methanococcus. In some embodiments, the one or more methanogens are selected from Methanobacterium formicicum, Methanobacterium bryantii, Methanobrevibacter ruminantium, Methanobrevibacter millerae, Methanobrevibacter olleyae, Methanomicrobium mobile, Methanoculleus olentangyi, Methanosarcina barkeri, Methanobrevibacter boviskoreani, Methanobacterium beijingense, Methanoculleus marisnigri, Methanoculleus bourgensis, Methanosarcina mazei, Methanobrevibacter gottschalkii, Methanobrevibacter thaueri, Methanobrevibacter smithii, Methanosphaera stadtmanae, Methanobrevibacter woesei and Methanobrevibacter wolinii. In some examples, the one or more methanogens is Methanococcus maripaludis.

### Methods of Manufacture

The compositions described herein may be made by combining trihalomethane other than dibromochloromethane, for example bromoform or iodoform, with the at least one other compound described herein. The animal feed compositions described herein may be made by combining an animal feed with the compositions described herein, i.e., trihalomethane other than dibromochloromethane, for example, bromoform or iodoform, and the at least one other compound described herein. These components are combined in suitable amounts to obtain a composition having the desired quantity and/or concentration of each component. Each component may be combined with one or more other components in any order and combination suitable to obtain the desired product. For example, each component may be combined by mixing or blending, for example, by top-dressing. Such methods are well known in the art. The composition may be prepared in the dry solid form, for example, powder form, and subject to further processing step depending on the types of the formulation for the intended finished products. The methods may further comprise a forming step, wherein the mixture is moulded, pressed, spray dried or otherwise formed into a shape (e.g., bar, ball, pellet, clusters, tablet), preferably with dimensions and/or textures suitable for consumption by an animal of the types described herein. The methods may comprise housing the composition or animal feed composition in a specific delivery device such as a syringe. The method may comprise forming the composition or animal feed composition into a bolus tablet that may be intended to stay in the stomach of the animal (e.g., rumen of the ruminant animal).

The compositions and animal feed compositions described herein may be packaged in a protective packaging material, such as Flexible Intermediate Bulk Container (FIBC), woven bags, paper bags, aluminium bags or polyethylene bags. The compositions and animal feed compositions may be packaged in a watertight and/or an airtight material in a box or vacuum-packed. The animal feed compositions may be packed under nitrogen to prevent degradation by oxygen.

The present disclosure may be described by way of one or more of the following paragraphs:
1. A composition comprising bromoform and at least one other compound selected from dibromochloromethane, diallyl disulfide, diallyl trisulfide, dimethyl disulfide, dipropyl disulfide, prenylnaringenin (for example, 6-prenylnaringenin or 8-prenylnaringenin), bavachin, bavachinin, corylifol (for example, corylifol A or corylifol C), morusin, isobavachalcone, naringenin, quercetin, xanthohumol, tannic acid, cinnamon bark oil, garlic oil, sandalwood oil, thyme red oil, lemongrass oil, lemon verbena oil, carvacrol, citral, cinnamaldehyde, hexylcinnamaldehyde (for example, α-hexylcinnamaldehyde or 2-hexylcinnamaldehyde), sclareol, saikosaponin (for example, saikosaponin A, saikosaponin b2, saikosaponin C or saikosaponin D), ursolic acid, ginsenoside (for example, ginsenoside Rb1, ginsenoside Rb2, ginsenoside Rc, ginsenoside Rd, ginsenoside Re, ginsenoside Rg1 or ginsenoside Rf), dibromoacetic acid and 3-nitrooxypropanol, and any combination thereof.
2. The composition of paragraph 1, wherein the at least one other compound is dibromochloromethane.
3. The composition according to paragraph 1, wherein the at least one other compound is selected from diallyl disulfide, diallyl trisulfide, dimethyl disulfide and dipropyl disulfide.
4. The composition according to paragraph 1, wherein the at least one other compound is selected from prenylnaringenin (for example, 6-prenylnaringenin or 8-prenylnaringenin), bavachin, bavachinin, corylifol (for example, corylifol A or corylifol C), morusin, isobavachalcone, naringenin, quercetin and xanthohumol.
5. The composition according to paragraph 1, wherein the at least one other compound is tannic acid.
6. The composition according to paragraph 1, wherein the at least one other compound is selected from cinnamon bark oil, garlic oil, sandalwood oil, thyme red oil, lemongrass oil and lemon verbena oil.
7. The composition according to paragraph 1, wherein the at least one other compound is selected from carvacrol, citral, cinnamaldehyde and hexylcinnamaldehyde (for example, α-hexylcinnamaldehyde or 2-hexylcinnamaldehyde).
8. The composition according to paragraph 1, wherein the at least one other compound is selected from sclareol, saikosaponin (for example, saikosaponin A, saikosaponin b2, saikosaponin C or saikosaponin D), ursolic acid and ginsenoside (for example, ginsenoside Rb1, ginsenoside Rb2, ginsenoside Rc, ginsenoside Rd, ginsenoside Re, ginsenoside Rg1 or ginsenoside Rf).
9. The composition according to paragraph 1, wherein the at least one other compound is dibromoacetic acid.
10. The composition according to paragraph 1, wherein the at least one other compound is 3-nitrooxypropanol.
11. The composition according to any one of the preceding paragraphs, wherein the ratio of the concentration of bromoform to the at least one other compound is from about 1:1 to about 1:10,000.
12. The composition according to paragraph 1, wherein the compound is:
   (i) dibromochloromethane and the ratio of the concentration of bromoform to dibromochloromethane is from 1:1 to 1:2; or
   (ii) selected from diallyl disulfide, diallyl trisulfide, dimethyl disulfide and dipropyl disulfide and the ratio of the concentration of bromoform to said compound is from about 1:100 to about 1:10,000, for example, from about 1:500 to about 1:10,000, or from about 1:750 to about 1:1250, or from about 1:7500 to about 1:9000; or
   (iii) selected from 8-prenylnaringenin, bavachin, bavachinin, corylifol A, morusin, isobavachalcone, naringenin, quercetin and xanthohumol and the ratio of the concentration of bromoform to said compound is from about 1:10 to about 1:1000, for example, from about 1:25 to about 1:1000, or from about 1:50 to about 1:100, or from about 1:50 to about 1:150; or
   (iv) tannic acid and the ratio of the concentration of bromoform to tannic acid is from about 1:500 to about 1:1500, for example, from about 1:750 to about 1:1000, or from about 1:800 to about 1:900; or
   (v) selected from cinnamon bark oil, garlic oil, sandalwood oil, thyme red oil, lemongrass oil and lemon verbena oil and the ratio of the concentration of bromoform to the amount of said compound is from about 1:100 to about 1:10,000, for example, from about 1:200 to about 1:9000, or from about 1:500 to about 1:2500, or from about 1:3000 to about 1:5000, or from about 1:7500 to 1:10,000, or from about 1:200 to about 1:300; or
   (vi) selected from carvacrol, citral, cinnamaldehyde and α-hexylcinnamaldehyde and the ratio of the concentration of bromoform to said compound is from about 1:200 to about 1:10,000, for example, from about 1:200 to about 1:300, or from about 1:3000 to about 1:9000, or from about 1:3000 to about 1:5000, or from about 1:7500 to about 1:10,000; or
   (vii) selected from sclareol, saikosaponin b2, ursolic acid and ginsenoside Rb2 and the ratio of the concentration of bromoform to said compound is from about 1:50 to about 1:1000, or from about 1:50 to about 1:250, or from about 1:750 to about 1:900; or
   (viii) is dibromoacetic acid and the ratio of the concentration of bromoform to dibromoacetic acid is from about 1:1000 to about 1:2000, for example, from about 1:1500 to about 1:1750; or
   (ix) is 3-nitrooxypropanol and the ratio of the concentration of bromoform to 3-nitrooxypropanol is from about 1:2 to about 1:20, for example, from about 1:5 to about 1:15.
13. The composition according to any preceding paragraph, wherein the concentration of bromoform in the composition is less than about 0.20 μM, for example, less than about 0.15 μM, optionally where the concentration of bromoform in the composition is at least about 0.05 μM, for example, at least about 0.10 μM.
14. The composition according to any preceding paragraph, wherein the concentration of the at least other compound is from about 1 μM to about 1.5 mM, for example, from about 10 μM to about 1 mM in respect of dibromochloromethane, diallyl disulfide, diallyl trisulfide, dimethyl disulfide and dipropyl disulfide, prenylnaringenin (for example, 6-prenylnaringenin or 8-prenylnaringenin), bavachin, bavachinin, corylifol (for example, corylifol A or corylifol C), morusin, isobavachalcone, naringenin, quercetin, xanthohumol, tannic acid, carvacrol, citral, cinnamaldehyde, hexylcinnamaldehyde (for example, α-hexylcinnamaldehyde or 2-hexylcinnamaldehyde), sclareol, saikosaponin (for example, saikosaponin A, saikosaponin b2, saikosaponin C or saikosaponin D), ursolic acid, ginsenoside (for example, ginsenoside Rb1, ginsenoside Rb2, ginsenoside Rc, ginsenoside Rd, ginsenoside Re, ginsenoside Rg1 or ginsenoside Rf), dibromoacetic acid and 3-nitrooxypropanol.
15. The composition according to any one of claims 1-13, wherein the amount of the at least one other compound in the composition is from about 10 ppm to about 500 ppm, for example, from about 10 ppm to about 250 ppm in respect of cinnamon bark oil, garlic oil, sandalwood oil, thyme red oil, lemongrass oil and lemon verbena oil.
16. Animal feed comprising the composition of any one of paragraphs 1-15, for example, wherein the animal feed is an animal feed supplement, or an animal feed additive, or a complementary feed.
17. Use of the composition according to paragraphs 1-15, or animal feed according to paragraph 16, to:
   a. reduce methane emission by an animal; and/or
   b. inhibit methanogenesis by one or more methanogens in an animal; and/or
   c. increase milk yield and/or body weight gain of an animal.
18. Use according to paragraph 17, wherein the composition is consumed by the animal.
19. Use according to paragraphs 17 or 18, wherein the animal is a ruminant animal such as a cow, goat or sheep.
20. A method of:
   a. reducing methane emission by an animal, and/or
   b. inhibiting methanogenesis by one or more methanogens in an animal, and/or
   c. increasing milk yield and/or body weight gain of an animal,
   the method comprising administering the composition according to any one of paragraphs 1-15, or the animal feed of paragraph 16, to the animal.
21. The method of according to paragraph 20, wherein the animal is a ruminant animal such as cow, goat or sheep.
22. A composition comprising iodoform and at least one other compound selected from dibromochloromethane, diallyl disulfide, diallyl trisulfide, dimethyl disulfide, dipropyl disulfide, prenylnaringenin (for example, 6-prenylnaringenin or 8-prenylnaringenin), bavachin, bavachinin, corylifol (for example, corylifol A or corylifol C), morusin, isobavachalcone, naringenin, quercetin, xanthohumol, tannic acid, cinnamon bark oil, garlic oil, sandalwood oil, thyme red oil, lemongrass oil, lemon verbena oil, carvacrol, citral, cinnamaldehyde, hexylcinnamaldehyde (for example, α-hexylcinnamaldehyde or 2-hexylcinnamaldehyde), sclareol, saikosaponin (for example, saikosaponin A, saikosaponin b2, saikosaponin C or saikosaponin D), ursolic acid, ginsenoside (for example, ginsenoside Rb1, ginsenoside Rb2, ginsenoside Rc, ginsenoside Rd, ginsenoside Re, ginsenoside Rg1 or ginsenoside Rf), dibromoacetic acid and 3-nitrooxypropanol, and any combination thereof.
23. The composition of paragraph 22, wherein the at least one other compound is dibromomethane.
24. The composition according to paragraph 22, wherein the at least one other compound is selected from diallyl disulfide, diallyl trisulfide, and dipropyl disulfide.
25. The composition according to paragraph 22, wherein the at least one other compound is naringenin.
26. The composition according to paragraph 22, wherein the at least one other compound is selected from garlic oil, thyme red oil, and lemongrass oil.
27. The composition according to paragraph 22, wherein the at least one other compound is hexylcinnamaldehyde, for example, α-hexylcinnamaldehyde.
28. The composition according to paragraph 22, wherein the at least one other compound is pyromellitic diimide.
29. The composition according to any one of paragraphs 22-28, wherein the ratio of the concentration of iodoform to the at least one other compound is from about 1:0.05 to about 1:10,000.
30. The composition according to paragraph 22, wherein the composition comprises iodoform and at least two other compounds selected from a group consisting of dibromomethane, pyromellitic diimide, naringenin, dipropyl disulfide, garlic oil, diallyl disulfide, diallyl trisulfide, hexylcinnamaldehyde (for example, α-hexylcinnamaldehyde), thyme red oil, lemongrass oil, and any combination thereof.
31. The composition according to paragraph 30, wherein the at least two other compounds are:
   (i) dibromomethane, and
   (ii) naringenin, dipropyl disulfide, garlic oil, diallyl disulfide, or diallyl trisulfide.
32. The composition according to paragraph 22-31, wherein the compound is:
   (i) dibromomethane and the ratio of the concentration of iodoform to dibromomethane is from about 1:0.05 to about 1:1, or about 1:0.1 to about 1:0.75, or from about 1:0.15 to about 1:0.5, or from about 1:0.2 to about 1:0.3; and/or
   (ii) selected from diallyl disulfide, diallyl trisulfide and dipropyl disulfide and the ratio of the concentration of iodoform to said compound is from about 1:1 to about 1:100, or from about 1:5 to about 1:50, or from about 1:10 to about 1:25, or from about 1:10 to about 1:20; or
   (iii) naringenin and the ratio of the concentration of iodoform to said compound is from about 1:1 to about 1:500, or from about 1:5 to about 1:250, or from about 1:10 to about 1:100, or from about 1:25 to about 1:75, or from about 1:40 to about 1:60; or
   (iv) is selected from garlic oil, thyme red oil and lemongrass oil and the ratio of the concentration of iodoform to the amount of said compound is from about 1:0.5 to about 1:100, or from about 1:1 to about 1:75, or from about 1:2.5 to about 1:50 or from about 1:5 to about 1:30; or
   (v) α-hexylcinnamaldehyde and the ratio of the concentration of iodoform to said compound is from about 1:1 to about 1:100, or from about 1:5 to about 1:50, or from about 1:10 to about 1:25, or from about 1:10 to about 1:20, or from about 1:10 to about 1:15; or
   (vi) pyromellitic diimide and the ratio of concentration of the iodoform to pyromellitic diimide is from about 1:0.05 to about 1:25, or from about 1:0.1 to about 1:10, or from about 1:0.5 to about 1:5, or from about 1:1 to about 1:2.5.
33. The composition according to paragraphs 22-31, wherein the concentration of iodoform in the composition is about 1 μM to about 25 μM, for example, from about 1.5 μM to about 12.5 μM.
34. The composition according to paragraphs 22-31, wherein the concentration of the at least other compound is from about 0.05 μM to about 50 μM, for example about 0.25 μM to about 12.5 M in respect of dibromomethane; from about 0.1 μM to about 100.0 μM, for example from about 15.0 μM to about 30.0 μM in respect of diallyl disulfide and diallyl trisulfide; from about 0.5 μM to about 100.0 μM, for example from about 20.0 μM to about 40.0 μM in respect of dipropyl disulfide; from about 25.0 μM to about 250.0 μM, for example, from about 90.0 μM to about 110.0 μM in respect of naringenin; from about 10.0 μM to about 75.0 μM, for example, from about 25.0 μM to about 35.0 μM in respect of α-hexylcinnamaldehyde.
35. The composition according to paragraphs 22-31, wherein the amount of the at least one other compound in the composition is from about 0.5 ppm, for example, is from about 5 ppm in respect of garlic oil; is from about 0.5 ppm to about 50 ppm, for example from about 15 ppm to about 25 ppm in respect of thyme red oil and lemongrass oil; is from about 0.1 ppm to about 10 ppm, for example from about 0.75 ppm to about 2.5 ppm in respect of pyromellitic diimide.
36. Animal feed comprising the composition of any one of paragraphs 22-35, for example, wherein the animal feed is an animal feed supplement, or an animal feed additive, or a complementary feed.
37. Use of the composition according to paragraphs 22-35, or animal feed according to paragraph 36, to:
   a. reduce methane emission by an animal; and/or
   b. inhibit methanogenesis by one or more methanogens in an animal; and/or
   c. increase milk yield and/or body weight gain of an animal.
38. Use according to paragraph 37, wherein the composition is consumed by the animal.
39. Use according to paragraphs 37 or 38, wherein the animal is a ruminant animal such as a cow, goat or sheep.
40. A method of:
   a. reducing methane emission by an animal, and/or
   b. inhibiting methanogenesis by one or more methanogens in an animal, and/or
   c. increasing milk yield and/or body weight gain of an animal, the method comprising administering the composition according to any one of paragraphs 1-35, or the animal feed of paragraph 36, to the animal.
41. The method of according to paragraph 40, wherein the animal is a ruminant animal such as cow, goat or sheep.

The invention will now be described, by way of reference only, to the following non-limiting examples.

### EXAMPLES

### Example 1—Inhibition of Methane Production by the Methanogenic Archaea Methanococcus Maripaludis by a Combination of Bromoform and Various at Least One Other Compounds (Each Referred to as Compound X)

For this experiment, bromoform was prepped at 100 mM by adding 8.75 μl bromoform to 991 μl DMSO. This was diluted 10× to generate a 10 mM solution and further diluted to generate 0.12 mM stock solutions. Compound X stock solutions were prepared in DMSO (except for tannic acid, which was diluted in deionized water), to achieve the desired stock solutions required for testing. The experiment was set up by adding 5 ml of M141 medium (https://www.dsmz.de/microorganisms/medium/pdf/DSMZ_Medium141.pdf) to a screw cap Hungate tube followed by the addition of 5 μl Compound X and/or 5 μl bromoform or 5/10 μl DMSO as follows:
Tube 1: DMSO (10 μl)
Tube 2: Bromoform (5 μl, 0.120 mM) (120 nM final)+5 μl DMSO
Tube 3: Compound X (5 μl stock solution)+5 μl DMSO
Tube 4: Bromoform (5 μl 0.120 mM) (120 nM final)+Compound X (5 μl stock solution)

The concentration of Bromoform was fixed at 0.12 μM. This concentration is too low to inhibit methanogen on its own.

After the addition of the test substances, 500 μl of an overnight M. maripaludis culture was added to each reaction tube. Each tube was gassed with 80% H₂/20% CO₂ to 240 kPa and incubated at 37° C. for 24 h.

After the 24 h incubation the pressure inside the tube was measured using a manometer. Given that 5 moles of H₂/CO₂ are consumed to generate 1 mole of CH₄ the drop in pressure observed was used to calculate the amount of methane by the control and test reactions from which a percent inhibition was calculated.

Table 1 below summarises the range of concentrations and the fold increase in inhibition of Compound X when tested with bromoform relative to the level of inhibition for Compound X when tested alone.

TABLE 1

| | Concentration range | | | | Fold increase of Compound X |
|---|---|---|---|---|---|
| | in combination with | | Methane inhibition in | Methane inhibition of | combined with bromoform as |
| | Bromoform that were | | combination with | Compound X as a sole | compared to Compound X |
| Compound X | tested | | Bromoform (%) | compound (%) | alone |
| Dibromochloromethane | 0.195 | μM | 92.2 | 1 | 92.2 |
| Diallyl disulfide | 15.6 μM-250 μM | | 88.8 | 1 | 88.8 |
| Diallyl trisulfide | 125 | μM | 27.1 | 1 | 27.1 |
| Dimethyl disulfide | 1 | mM | 43.5 | 1 | 43.5 |
| Dipropyl disulfide | 1 | mM | 43.5 | 27.7 | 1.57 |
| 8-prenylnaringenin | 12.5 | μM | 97.2 | 76.4 | 1.27 |
| Bavachin | 25 | μM | 57.4 | 1 | 57.4 |
| Bavachinin | 12.5 μM-100 μM | | 97.2 | 43 | 2.26 |
| Corylifol A | 3.125 | μM | 96.1 | 1 | 96.1 |
| Morusin | 1.25 μM-10 μM | | 96.7 | 44.8 | 2.16 |
| Isobavachalcone | 3.125 μM-6.25 μM | | 93.4 | 83.4 | 1.12 |
| Naringenin | 100 | μM | 90.3 | 1 | 90.3 |
| Quercetin | 50 μM-100 μM | | 91.2 | 75.3 | 1.21 |
| Xanthohumol | 6.25 μM-12.5 μM | | 95.1 | 63.6 | 1.5 |
| Tannic acid | 100 | μM | 56.1 | 48.3 | 1.16 |
| Cinnamon bark oil | 250 | ppm | 99.4 | 11.7 | 8.48 |
| Garlic oil | 31.25 ppm-62.5 ppm | | 91.7 | 56.7 | 1.62 |
| Sandalwood oil | 7.8 | ppm | 96.7 | 5.6 | 17.4 |
| Thyme Red oil | 125 | ppm | 97.2 | 62.6 | 1.55 |
| Lemongrass oil | 125 | ppm | 83.2 | 1 | 83.2 |
| Lemon Verbena oil | 125 | ppm | 98.9 | 76.7 | 1.29 |
| Carvacrol | 500 | μM | 79.6 | 69.6 | 1.14 |
| Citral | 500 | μM | 96.7 | 13.3 | 7.29 |
| Cinnamaldehyde | 1 | mM | 91.7 | 1 | 91.7 |
| α-Hexylcinnamaldehyde | 31.25 | μM | 97.2 | 1 | 97.2 |
| Sclareol | 25 | μM | 61.2 | 1.1 | 56 |
| Saikosaponin b2 | 10 | μM | 55.6 | 1 | 55.6 |
| Ursolic Acid | 100 | μM | 85.2 | 1 | 85.2 |
| Ginsenoside Rb2 | 20 | μM | 66.9 | 44.7 | 1.42 |
| Dibromoacetic acid | 200 | μM | 88.1 | 1 | 88.1 |

| | | | | |
|---|---|---|---|---|
| 3-Nitrooxypropanol | 0.78 μM-1.56 μM | 91.3 | 1 | 91.3 |

### Example 2-Inhibition of Methane Production by a Combination of Iodoform and at Least One Other Compound

Various samples of single species, extracts, two-species combinations, and three-species combinations were assessed for their potential to inhibit methane production. This evaluation was carried out using in vitro fermentation assays known as Gas Tests. In each Gas Test, 250 mg of total meal ration (TMR) comprising 30% grass, 30% corn, and 40% complete feed was introduced into 100 ml serum vials as the substrate for the fermentation process. Rumen fluid, obtained from fistulated cows at the University of Reading, was mixed with degassed reaction buffer (1.6 L) and supplemented with Na₂S (82 ml). Subsequently, 30 ml of the rumen fluid/buffer mixture was added to each serum vial.

The test substances were dissolved in 100% ethanol, and 100 μl of each test substance was added to the serum vials containing the rumen fluid/buffer mixture. All test substances and controls were examined in triplicate for each experiment. Once the test substances and controls were added, the vials were sealed with butyl rubber stoppers and aluminium crimps, then incubated at 39° C. for 24 hours. Following incubation, gas samples were collected from both the control and test vials, and methane levels were determined using gas chromatography.

For each test compound, the “percentage inhibition of methane produced” was calculated using the following formula:

$$\% i nhibition = 100 - ( {Methane}_{test} / {Methane}_{control} \times 100 )$$

The test substances underwent evaluation in three independent Gas Tests, and an average percentage inhibition was calculated for each substance.

### Two-Species Combination

Synergy between substances was determined using the Bliss Independence Model using the following equation:

$${I}_{A B} = {I}_{A} + {I}_{B} - {I}_{A} {I}_{B}$$

Where I_{AB} is the predicted percentage methane inhibition of both substances together and I_{A} and I_{B} are the observed percentage methane inhibitions of the individual substances. The predicted percentage methane inhibition of both substances (I_{AB}) and the observed percent methane inhibition of both substances (I_{ob}) are used to calculate the Combination index (Ci) as follows:

$$Ci = {I}_{A B} / {I}_{ob}$$

If the Ci<1 then the two substances are synergistic.

### Three-Species Combination

Synergy between substances was determined using the following calculation:

$${I}_{A B C} = {I}_{A} + {I}_{B} + {I}_{C} - {I}_{A} {I}_{B} - {I}_{A} {I}_{C} - {I}_{B} {I}_{C} - {I}_{A} {I}_{B} {I}_{C}$$

Where I_{ABC} is the predicted percentage methane inhibition of the three substances together and I_{A}, I_{B} and I_{C} are the observed percentage methane inhibitions of the individual substances.

The predicted percentage methane inhibition of the three substances (I_{ABC}) and the observed percent methane inhibition of the combination of the three substances (I_{ob}) are used to calculate the Combination index (Ci) as follows:

$$Ci = {I}_{ABC} / {I}_{ob}$$

If the Ci<1 then the two substances are synergistic.

Table 1 shows the observed methane inhibition of the single species.

Table 2 shows the methane inhibition of two-species combinations along with the Ci values for each combination.

Table 3 shows the methane inhibition of three-species combinations along with the Ci values for each combination.

The corresponding graphs illustrating the methane inhibition of the single species, two-species combinations and three-species combinations can be found in the Figures section.

TABLE 2
Methane inhibition of sole compound

| | Average of observed |
|---|---|
| Compound | methane inhibition (%) |
| Iodoform (2 μM) | 40.8 |
| Iodoform (10 μM) | 98.3 |
| Dibromomethane (0.5 μM) | 14.5 |
| Dibromomethane (10 μM) | 99 |
| Pyromellitic diimide (1 μg/ml) | 20 |
| Naringenin (100 μM) | 10 |
| Dipropyl disulfide (30 μM) | 3 |
| Garlic Oil (5 μg/ml) | 1 |
| Diallyl trisulfide (25 μM) | 11 |
| Diallyl disulfide (25 μM) | 5 |
| α-Hexylcinnamaldehyde (25 μM) | 8 |
| Thyme red oil (20 μg/ml) | 5 |
| Lemongrass oil (20 μg/ml) | 5 |
| Bromoform 0.1 μM | 1.3 |
| Bromoform 1 μM | 92.4 |

TABLE 3
Methane inhibition of two-species combination

| | Average of | | |
|---|---|---|---|
| | observed | Predicted | |
| | methane | methane | |
| | inhibition | inhibition | |
| Double combination | (%) | (%) | Ci |
| Iodoform (2 μM) + Dibromomethane (0.5 μM) | 83.79 | 49.4 | 0.59 |
| Iodoform (2 μM) + Pyromellitic diimide (1 μg/ml) | 98 | 52.6 | 0.54 |
| Iodoform 2 μM + Naringenin (100 μM) | 61 | 46.8 | 0.76 |
| Iodoform 2 μM + DPDS (30 μM) | 72 | 42.6 | 0.59 |
| Iodoform 2 μM + Garlic Oil (5 μg/ml) | 70 | 41.4 | 0.60 |
| Iodoform 2 μM + DATS (25 μM) | 79 | 47.4 | 0.60 |
| Iodoform 2 μM + DADS (25 μM) | 80 | 43.8 | 0.55 |
| Iodoform 2 μM + α-Hexylcinnamaldehyde (25 μM) | 65 | 45.2 | 0.70 |
| Iodoform 2 μM + Thyme red oil (20 μg/ml) | 61 | 43.8 | 0.72 |
| Iodoform 2 μM + Lemongrass oil (20 μg/ml) | 66 | 43.8 | 0.66 |

TABLE 4
Methane inhibition of three-species combination

| | Average of | | |
|---|---|---|---|
| | observed | Predicted | |
| | methane | methane | |
| | inhibition | inhibition | |
| Triple combination | (%) | (%) | Ci |
| Iodoform (2 μM) + DBM (0.5 μM) + | 100 | 53.4 | 0.53 |
| Naringenin (100 μM) | | | |
| Iodoform (2 μM) + DBM (0.5 μM) + | 100 | 53.8 | 0.54 |
| DATS (25 μM) | | | |
| Iodoform (2 μM) + DBM (0.5 μM) + | 100 | 49.8 | 0.50 |
| Garlic oil (5 μg/ml) | | | |
| Iodoform (2 μM) + DBM (0.5 μM) + | 100 | 51.4 | 0.51 |
| DADS (25 μM) | | | |
| Iodoform (2 μM) + DBM (0.5 μM) + | 100 | 50.6 | 0.51 |
| DPDS (30 μM) | | | |

The results obtained from the combinations of iodoform with both pure compounds and plant extracts/oils demonstrated significant synergistic effects in methane inhibition, providing valuable insights for developing effective strategies to mitigate methane emissions.

When iodoform was combined with specific pure compounds such as dibromomethane, pyromellitic diimide, DPDS, DATS, alpha-hexylcinnamaldehyde, and naringenin, as well as plant extracts/oils such as garlic oil, thyme oil, and lemongrass oil, synergistic effects were observed. This indicates that utilizing these combinations can lead to stronger methane inhibition compared to using the species individually. Moreover, the synergistic interactions suggest the potential for reducing the required quantity of each compound, enhancing cost-effectiveness in methane mitigation strategies.

The identification of synergistic interactions presents an opportunity to develop sustainable approaches for reducing methane emissions in livestock. These combinations may help to achieve stronger methane inhibition while potentially minimizing the required amount of each compound. This has significant implications for optimizing methane reduction strategies in terms of effectiveness and resource utilization.

Implementing these synergistic combinations holds promise for advancing environmentally friendly practices in the agricultural sector, promoting sustainable livestock production, and mitigating the environmental impact of methane emissions.

1. A composition comprising a trihalomethane other than dibromochloromethane and at least one other compound selected from dibromochloromethane, dibromomethane, diallyl disulfide, diallyl trisulfide, dimethyl disulfide, dipropyl disulfide, prenylnaringenin, bavachin, bavachinin, corylifol, morusin, isobavachalcone, naringenin, quercetin, xanthohumol, tannic acid, cinnamon bark oil, garlic oil, sandalwood oil, thyme red oil, lemongrass oil, lemon verbena oil, carvacrol, citral, cinnamaldehyde, hexylcinnamaldehyde, sclareol, saikosaponin, ursolic acid, ginsenoside, dibromoacetic acid, 3-nitrooxypropanol, pyromellitic diimide, and any combination thereof.

2. The composition of claim 1, wherein the at least one other compound is dibromochloromethane or dibromomethane.

3. (canceled)

4. The composition according to claim 1, wherein the at least one other compound is selected from diallyl disulfide, diallyl trisulfide, dimethyl disulfide and dipropyl disulfide.

5. The composition according to claim 1, wherein the at least one other compound is selected from prenylnaringenin, bavachin, bavachinin, corylifol, morusin, isobavachalcone, naringenin, quercetin and xanthohumol.

6. The composition according to claim 1, wherein the at least one other compound is tannic acid.

7. The composition according to claim 1, wherein the at least one other compound is selected from cinnamon bark oil, garlic oil, sandalwood oil, thyme red oil, lemongrass oil and lemon verbena oil.

8. The composition according to claim 1, wherein the at least one other compound is selected from carvacrol, citral, cinnamaldehyde and hexylcinnamaldehyde.

9. The composition according to claim 1, wherein the at least one other compound is selected from sclareol, saikosaponin, ursolic acid and ginsenoside.

10. The composition according to claim 1, wherein the at least one other compound is dibromoacetic acid, 3-nitrooxypropanol, or pyromellitic diimide.

11-13. (canceled)

14. The composition according to claim 1, wherein the trihalomethane is bromoform.

15. The composition according to claim 1, wherein the trihalomethane is iodoform.

16. The composition according to claim 15, wherein the composition comprises iodoform and at least two other compounds selected from a group consisting of dibromomethane, pyromellitic diimide, naringenin, dipropyl disulfide, garlic oil, diallyl disulfide, diallyl trisulfide, hexylcinnamaldehyde, thyme red oil, lemongrass oil, and any combination thereof.

17. The composition according to claim 16, wherein the at least two other compounds are:
(i) dibromomethane and
(ii) naringenin, dipropyl disulfide, garlic oil, diallyl disulfide, or diallyl trisulfide.

18. The composition according to claim 14, wherein the compound is:
(i) dibromochloromethane and the ratio of the concentration of bromoform to dibromochloromethane is from 1:1 to 1:2; or
(ii) selected from diallyl disulfide, diallyl trisulfide, dimethyl disulfide and dipropyl disulfide and the ratio of the concentration of bromoform to said compound is from about 1:7500 to about 1:9000; or
(iii) selected from 8-prenylnaringenin, bavachin, bavachinin, corylifol A, morusin, isobavachalcone, naringenin, quercetin and xanthohumol and the ratio of the concentration of bromoform to said compound is from about 1:50 to about 1:150; or
(iv) tannic acid and the ratio of the concentration of bromoform to tannic acid is from about 1:800 to about 1:900; or
(v) selected from cinnamon bark oil, garlic oil, sandalwood oil, thyme red oil, lemongrass oil and lemon verbena oil and the ratio of the concentration of bromoform to the amount of said compound is from about 1:200 to about 1:300; or
(vi) selected from carvacrol, citral, cinnamaldehyde and α-hexylcinnamaldehyde and the ratio of the concentration of bromoform to said compound is from about 1:7500 to about 1:10,000; or
(vii) selected from sclareol, saikosaponin b2, ursolic acid and ginsenoside Rb2 and the ratio of the concentration of bromoform to said compound is from about 1:750 to about 1:900; or
(viii) dibromoacetic acid and the ratio of the concentration of bromoform to dibromoacetic acid is from about 1:1500 to about 1:1750; or
(ix) 3-nitrooxypropanol and the ratio of the concentration of bromoform to 3-nitrooxypropanol is from about 1:5 to about 1:15.

19. The composition according to claim 15, wherein the compound is:
(i) dibromomethane and the ratio of the concentration of iodoform to dibromomethane is from about 1:0.2 to about 1:0.3; and/or
(ii) selected from diallyl disulfide, diallyl trisulfide and dipropyl disulfide and the ratio of the concentration of iodoform to said compound is from about 1:10 to about 1:20; or
(iii) naringenin and the ratio of the concentration of iodoform to said compound is from about 1:40 to about 1:60; or
(iv) is selected from garlic oil, thyme red oil and lemongrass oil and the ratio of the concentration of iodoform to the amount of said compound is from about 1:5 to about 1:30; or
(v) α-hexylcinnamaldehyde and the ratio of the concentration of iodoform to said compound is from about 1:10 to about 1:15; or
(vi) pyromellitic diimide and the ratio of concentration of the iodoform to pyromellitic diimide is from about about 1:1 to about 1:2.5.

20. The composition according to claim 14, wherein the concentration of bromoform in the composition is about 0.10 μM to about 0.15 μM.

21. The composition according to claim 14, wherein the concentration of the at least other compound is from about 1 μM to about 1.5 mM in respect of dibromochloromethane, diallyl disulfide, diallyl trisulfide, dimethyl disulfide and dipropyl disulfide, prenylnaringenin, bavachin, bavachinin, corylifol, morusin, isobavachalcone, naringenin, quercetin, xanthohumol, tannic acid, carvacrol, citral, cinnamaldehyde, hexylcinnamaldehyde, sclareol, saikosaponin, ursolic acid, ginsenoside, dibromoacetic acid, and 3-nitrooxypropanol.

22. The composition according to claim 14, wherein the amount of the at least one other compound in the composition is from about 10 ppm to about 250 ppm in respect of cinnamon bark oil, garlic oil, sandalwood oil, thyme red oil, lemongrass oil, and lemon verbena oil.

23. The composition according to claim 15, wherein the concentration of iodoform in the composition is about 1.5 μM to about 12.5 μM.

24. The composition according to claim 15, wherein the concentration of the at least other compound is from about 0.25 μM to about 12.5 μM in respect of dibromomethane; from about 15.0 μM to about 30.0 μM in respect of diallyl disulfide and diallyl trisulfide; from about 20.0 μM to about 40.0 μM in respect of dipropyl disulfide; from about 90.0 μM to about 110.0 μM in respect of naringenin; from about 25.0 μM to about 35.0 μM in respect of α-hexylcinnamaldehyde.

25. The composition according to claim 15, wherein the amount of the at least one other compound in the composition is from about 5 ppm in respect of garlic oil; is from about 15 ppm to about 25 ppm in respect of thyme red oil and lemongrass oil; is from about 0.75 ppm to about 2.5 ppm in respect of pyromellitic diimide.

26. Animal feed comprising the composition of claim 1, for example, wherein the animal feed is an animal feed supplement, an animal feed additive, or a complementary feed.

27-29. (canceled)

30. A method of:
a. reducing methane emission by an animal, and/or
b. inhibiting methanogenesis by one or more methanogens in an animal, and/or
c. increasing milk yield and/or body weight gain of an animal,
the method comprising: administering the composition according to claim 1 to the animal.

31. (canceled)
